(19) United States
(12) Patent Application Publication
(10) Pub. No.: US 2024/0167625 A1
(43) Pub. Date: May 23, 2024

(54) MICROCRACKING AND PERMEABILITY RESISTANT COMPOSITE MATERIALS, ARTICLES, AND METHODS

(71) Applicant: University of Dayton, Dayton, OH (US)

(72) Inventors: Brian Rice, Mason, OH (US); Kevin Retz, West Chester, OH (US); Paul Kladitis, Clayton, OH (US); Lingchuan Li, Dayton, OH (US)

(21) Appl. No.: 18/492,555

(22) Filed: Oct. 23, 2023

Related U.S. Application Data
(60) Provisional application No. 63/418,209, filed on Oct. 21, 2022.

(51) Int. Cl. F17C 1/00; F17C 5/00

(52) U.S. Cl. CPC F17C 1/00; F17C 5/00; F17C 2203/0624; F17C 2203/0673; F17C 2203/068; F17C 2221/012; F17C 2223/0161

(57) ABSTRACT

Provided are microcrack-resistant compositions, apparatuses comprising microcrack-resistant materials, and methods of containing fluids. More specifically, the present disclosure provides microcrack-resistant laminate compositions comprising interdisposed vertically aligned carbon nanotubes. The present disclosure additionally provides microcrack-resistant fluid tanks. Further, the present disclosure provides methods of containing a cryogenic fluid without leaks.

### CROSS REFERENCE TO RELATED APPLICATIONS

This application claims priority under 35 U.S.C. § 119 to U.S. Provisional Application No. 63/418,209 filed Oct. 21, 2022, which is incorporated by reference herein in its entirety.

### FIELD

This invention relates to the suppression of microcracking in composite materials during mechanical loading, and more particularly, to incorporating vertically aligned carbon nanotubes (VACNTs) and, optionally, horizontally aligned carbon nanotubes (HACNTs) to suppress the microcracking and reduce permeability, while at the same time strengthening the composite, under cryogenic and non-cryogenic conditions.

### BACKGROUND

Vertically aligned carbon nanotubes (VACNTs) interleaved between the plies of a laminate composite (commercially known as NAWAstitch™) have been shown to suppress and arrest microcracking during mechanical loading under cryogenic conditions. Such microcracks can eventually join to become larger cracks and result in a leaking or exploding tank. The same VACNT layer can be mechanically rolled into a horizontal alignment of the carbon nanotubes (HACNTs), covering the outer surface of a composite structure to act as a non-permeable liner that matches the coefficient of thermal expansion (CTE) of the composite which is critical for composite, liquid/gas, storage tanks that operate under widely varying temperature conditions such as cryogenic conditions, whereas otherwise a liner that does not have a matching CTE will eventually detach from the tank surface and resulting in a leaking or exploding tank. The HACNT liner can be fixed to the composite surface using the host composite matrix or a different matrix.

Cryogenic storage tanks for fuel for spacecraft, aircraft, and road vehicles are projected to become more in demand than any other time in history due to interest in alternative sources of energy to fossil fuels. The tanks will need to be light and strong which require composites. However, constant thermal cycling of the tanks is anticipated to be harmful to the tanks' structural integrity. The present disclosure addresses this need.

### SUMMARY

The present disclosure provides microcrack-resistant materials, apparatuses for containing cryogenic fluid, and methods of containing cryogenic fluid.

In an aspect, the present disclosure provides a microcrack-resistant laminate composition comprising: at least two plies, each ply comprising carbon-fiber fabric impregnated with resin; and interdisposed between each pair of plies, a substantially aligned aggregate of carbon nanotubes oriented substantially orthogonally to the plies. In any embodiment, the microcrack-resistant laminate composition may comprise interdisposed between at least one pair of plies or disposed on an outer surface of an outmost ply, a layer comprising an aggregate of substantially aligned carbon nanotubes oriented substantially horizontally to the plies. In any embodiment, the composition may comprise a layer comprising an aggregate of substantially aligned carbon nanotubes oriented substantially horizontally to the plies interdisposed between at least one pair of plies, disposed on an outer surface of an outmost ply, or the composition may comprise layers comprising an aggregate of substantially aligned carbon nanotubes oriented substantially horizontally to the plies interdisposed between at least one pair of plies and disposed on an outer surface of an outmost ply. In any embodiment, the composition may comprise a layer of carbon nanotubes oriented substantially horizontally to the plies interdisposed at a midplane of the laminate.

In any embodiment, the composition may have a ply orientation formula of [0/90]₄ₛ. In any embodiment, the composition may have a ply orientation formula of [+45/90/−45/0]₂ₛ.

In any embodiment, the composition may comprise at least four plies. In any embodiment, the composition may comprise 16 plies.

In any embodiment, the resin may be a thermosetting resin that cures at 160° C.

In any embodiment, the carbon-fiber fabric may be unidirectional.

In another aspect, the present disclosure provides a microcrack-resistant fluid tank comprising: a tank shell forming an internal volume configured to receive and contain cryogenic fluid, the tank shell comprising a carbon-fiber laminate comprising at least four plies, each ply comprising a carbon-fiber fabric impregnated with resin, between each pair of plies is a forest of carbon-nanotubes orthogonal to the plies, and between at least one pair of plies or on an inner surface of the tank shell is a layer of carbon nanotubes oriented substantially horizontally to the plies. In any embodiment of the fluid tank, the carbon-fiber laminate may comprise 16 plies.

In any embodiment, there may be, interdisposed in an area between the pair of plies forming a midplane, a layer of carbon nanotubes oriented substantially horizontally to the plies. In any embodiment, the tank may comprise on an inner surface of the tank shell a layer of carbon nanotubes oriented substantially horizontally to the plies.

In any embodiment of the fluid tank, microcracks do not propagate between plies when the tank shell is thermocycled at least five times between room temperature and a temperature under about 20 kelvins. In any embodiment of the tank, microcracks do not propagate between plies when the tank shell is thermocycled at least five times between room temperature and a temperature under about 77 kelvins.

In any embodiment of the fluid tank, the tank may receive and contain cryogenic fluid without microcracks propagating between plies.

In still another aspect, the present disclosure provides a method of containing cryogenic fluid without leaks, the method comprising: filling a tank with a cryogenic fluid, the tank comprising a tank shell forming an internal volume configured to receive and contain the cryogenic fluid, the tank shell comprising a carbon-fiber laminate comprising at least four plies, each ply comprising a carbon-fiber fabric impregnated with resin, wherein interdisposed between each pair of plies is a forest of carbon-nanotubes orthogonal to the plies, and wherein interdisposed between at least one pair of plies or disposed on in inner surface of the tank shell is a layer of carbon nanotubes oriented substantially horizontally to the plies; and retaining the cryogenic fluid inside the tank.

In any embodiment of the method, the cryogenic fluid may be liquid hydrogen.

In any embodiment of the method, the cryogenic fluid may have a permeability through the tank shell of less than 1×10⁻¹⁸ mol/s/m/Pa at a cryogenic temperature. In any embodiment of the method, the cryogenic temperature may be about 77 kelvins. In any embodiment, the cryogenic temperature may be about 20 kelvins.

In may be appreciated that the above-mentioned embodiments are only exemplary, and numerous embodiments are contemplated within the scope of the present disclosure, which may be better understood with reference to the description below.

### BRIEF DESCRIPTION OF THE FIGURES

The above-mentioned and other features and advantages of the various embodiments of the present disclosure, and the manner of attaining them, will become more apparent and better understood by reference to the following accompanying non-limiting drawings, wherein:

FIGS. 1A-1B are perspective views of a cross-section of an exemplary embodiment of the composition of the present disclosure. FIG. 1A shows a four-ply embodiment. It may be appreciated that the laminate plies may be described as laid up in a Z-axis direction, while the horizontal plane may be described using X-axis and Y-axis directions. FIG. 1B is a partially exploded perspective view of the same embodiment.

FIG. 2 is a perspective view of a cross-section of an exemplary pair of plies of the composition of the present disclosure.

FIG. 3 is a micrograph of a cross-section of a pair of plies of the composition of the present disclosure. Vertically-aligned carbon nanotubes (VACNTs) are seen interdisposed orthogonally between a 0°-oriented carbon-fiber ply and a 90°-oriented carbon-fiber ply.

FIG. 4A-4B are microscopy images of a cross section of a “baseline” carbon fiber laminate composition lacking VACNTs, after exposure to cryogenic temperatures of −320° F. FIG. 4A shows the micrograph. FIG. 4B shows the same micrograph, with microcracks propagating through multiple laminate layers circled in white. The images show test results for cyclic testing (Cryo) with the baseline laminate showing consistent behavior of cracks propagating through the ply interface to neighboring plies.

FIG. 5 is a microscopy image of a cross section of composition of the present disclosure, after exposure to cryogenic temperatures of −320° F., showing consistent behavior of no cracks propagating (“linking”) between plies.

FIGS. 6A-6C are higher-magnification microscopy images showing test results for cyclic testing (Cryo) with the baseline laminate composition showing consistent behavior of cracks propagating through the ply interface to neighboring plies. FIG. 6A shows a close-up view of a microcrack which has propagated through multiple laminate plies of a baseline specimen. The numbers to the left indicate the ply orientation angle. FIG. 6B is an additional close-up view of another microcrack which has propagated through multiple laminate plies of a baseline specimen. The numbers to the left indicate the ply orientation angle. FIG. 6C is a still further magnified close-up view of microcrack propagating through multiple laminate plies of a baseline specimen. The numbers to the right indicate the ply orientation angle. As shown in FIG. 6C, the pictured microcrack has propagated from the −45° ply, through the interstitial space between the −45° ply and 900 ply, and through the 90° ply. The VACNTs of the composition of the present disclosure, among other advantages, prevent such microcrack propagation between multiple laminate plies.

FIG. 7 is a higher-magnification microscopy image of a cross section of composition of the present disclosure, after exposure to cryogenic temperatures of −320° F., showing consistent behavior of no cracks propagating (“linking”) between plies.

FIGS. 8A-8C are scanning electron microscopy images of a cross section of an embodiment of the composition of the present disclosure having a layer of horizontally aligned carbon nanotubes (HACNTs). The cross section shown was cut from a central portion of a test material. FIG. 8A is shown at the least magnification (scale bar=100 μm); FIG. 8B is shown at greater magnification (scale bar=2.00 μm); and FIG. 8C is shown at highest magnification (scale bar=1.00 μm).

FIGS. 9A-9C are additional scanning electron microscopy images of a cross section of an embodiment of the composition of the present disclosure having a layer of horizontally aligned carbon nanotubes (HACNTs). The cross section shown was cut from a central portion of a test material. FIG. 9A is shown at the least magnification (scale bar=100 μm); FIG. 9B is shown at greater magnification (scale bar=2.00 μm); and FIG. 9C is shown at highest magnification (scale bar=1.00 μm).

FIGS. 10A-10C are further scanning electron microscopy images of a cross section of an embodiment of the composition of the present disclosure having a layer of horizontally aligned carbon nanotubes (HACNTs). The cross section shown was cut from a central portion of a test material. FIG. 10A is shown at the least magnification (scale bar=100 μm); FIG. 10B is shown at greater magnification (scale bar=2.00 μm); and FIG. 10C is shown at highest magnification (scale bar=1.00 μm).

FIGS. 11A-11C are scanning electron microscopy images of a cross section of an embodiment of the composition of the present disclosure having a layer of horizontally aligned carbon nanotubes (HACNTs). The cross section shown was cut from an edge portion of a test material. FIG. 11A is shown at the least magnification (scale bar=100 μm); FIG. 11B is shown at greater magnification (scale bar=2.00 μm); and FIG. 11C is shown at highest magnification (scale bar=1.00 μm).

FIGS. 12A-12C are additional scanning electron microscopy images of a cross section of an embodiment of the composition of the present disclosure having a layer of horizontally aligned carbon nanotubes (HACNTs). The cross section shown was cut from an edge portion of a test material. FIG. 12A is shown at the least magnification (scale bar=100 μm); FIG. 12B is shown at greater magnification (scale bar=2.00 μm); and FIG. 12C is shown at highest magnification (scale bar=1.00 μm).

FIGS. 13A-13C are further scanning electron microscopy images of a cross section of an embodiment of the composition of the present disclosure having a layer of horizontally aligned carbon nanotubes (HACNTs). The cross section shown was cut from an edge portion of a test material. FIG. 14A is shown at the least magnification (scale bar=100 μm); FIG. 14B is shown at greater magnification (scale bar=2.00 μm); and FIG. 14C is shown at highest magnification (scale bar=1.00 μm).

FIGS. 14A-14B are scanning electron microscopy images of a cross section of an embodiment of the composition of the present disclosure having a layer of horizontally aligned carbon nanotubes (HACNTs). FIG. 14A shows a sample cut from a center portion of a test specimen. FIG. 14B shows a sample cut from an edge portion of a test specimen. (Scale bar=50.0 μm).

FIGS. 15A-15B are to halves of a bar graph showing relative standard-test mechanical room-temperature performance of baseline composite material versus the composition of the present disclosure. FIG. 15A shows the top half of the bar graph, relating to tests designated as “Short Beam Fatigue (80% Ult.)—34-700/NCT301-1”; “Short Beam Shear Quasi-isotropic—D2344—IM7/TC350-1”; “Interlaminar Tension 0.deg—D6415—IM7/TC275-1”; “Compression After Impact—D7136/D7137—34-700/NCT301-1”; and “Compression After Half-Impact—D7137 (3.3J/mm)—IM7/TC350-1”. FIG. 15B shows the bottom half of the bar graph, relating to tests designated as “Short Beam Shear Quasi-isotropic—D2344—IM7/8552”; “Compression After Impact—D7136/D7137-IM7/8552”; “Compression After Impact—D7137/D7137—IM7/TC350-1”; “Combined Loading Compression QI—D6641—IM7/TC350-1”; and “Short Beam Shear 0.deg—D2344—IM7/TC350-1”.

FIG. 16 is a table describing a test plan summary for mechanical room-temperature performance of baseline composite material versus the composition of the present disclosure.

FIGS. 17A-17B are illustrations of standard test laminate materials fabric layup for the panel for ASTM D3518 In-Plane Shear Specimens (FIG. 17A) and ASTM D5766 Open-Hole Tension Specimens (FIG. 17B). For the specimen of FIG. 17A, the Panel ID is 20220111 AJM_1 (panel 1). The Material is Teijen unitape prepreg with Q183 rapid-cure resin with HTS40 fiber (250 gsm). The Panel Size is 18”×36”. The stacking sequence is 16 piles at [0, 90]_{4S}. The Expected Cured-Ply Thickness is 0.01” and the Expected Panel Thickness is 0.16”. For the specimen of FIG. 17B, the Panel ID is 20220111_AJM_2 (panel 2). The Material is Teijin unitape prepreg with Q183 rapid-cure resin with HTS40 fiber (250 gsm). The panel size is 12”×24”. The Stacking Sequence is 16 piles at [0, 90]_{4S}. The expected Cured-Ply Thickness is 0.01”. The Expected Panel Thickness is 0.16”. Another specimen, ASTM D5766 Open-Hole Tension Specimens (another), Panel ID is 20220111_AJM (panel 3), had the following layup features: The Material is Teijin unitape prepreg with Q183 rapid-cure resin with HTS40 fiber (250 gsm). The panel size is 12”×24”. The stacking sequence is 16 piles at [45, 90,−45, 0]_{2S}. The expected cured-ply thickness is 0.01”. The expected panel thickness is 0.16”.

FIGS. 18A-18C depicts the cut plans for standard materials testing. FIG. 18A shows a cut plan for the ASTM D3518 In-Plane Shear Specimens (20220111 AJM_1) in small squares for acid digestion. illustrations of configuration of cuts, from which test strips of carbon fiber composite material were cut from starting test material. The elongated rectangular cut-out strips were subjected to standard acid testing. FIG. 18B shows the cut plan for ASTM D5766 Open-Hole Tension Specimens (20220111_AJM 2) in small squares for acid digestion. FIG. 18C shows the cut plan for ASTM D5766 Open-Hole Tension Specimens (20220111_AJM_3) in small squares for acid digestion,

FIG. 19 is a table describing physical properties of test specimens. The table depicts the physical characterization of fabricated dimensions and acid digestion per ASTM D3171 that assumes fiber density of 1.78 g/cm³ and averages of acid digestion specimens shown in cut plan. The carbon nanotube (CNT) volume assumes CNT density of 1.41 g/cm³ and is segregated from the matrix digestion products.

FIGS. 20A-20B are photographs of cryogenic test setup. FIG. 20A depicts the cryo test setup in which specimens were sealed into a stryofoam container with waterproof silicone sealant. The foam test chamber was filled with liquid nitrogen (LN2) (FIG. 20B). The aluminum blocks were added to increase thermal mass and displace some liquid. The tests were completed with minimal loss of LN2.

FIG. 21 is a graph depicting the test results for open hole tension (Cryo) with the initiation of microcracking. Audible cracking is a standard readout known to those skilled in the art. The first audible cracking for baseline specimen occurred at about 20 percent lower stress level than for VACNT reinforced specimen.

FIGS. 22A-22B are test results for open hole tension (Cryo) with stress-strain behavior. FIG. 22A shows tensile stress performance results for a baseline (negative control) specimen. FIG. 22B shows tensile stress performance results for a VACNT-reinforced specimen.

FIGS. 23A-23B are photographs of test specimens after failure condition. FIG. 23A shows baseline specimen; FIG. 23B shows VACNT-reinforced specimen.

FIGS. 24A-24B are the test results for open hole tension (RT) with stress-strain behavior. FIG. 24A shows tensile stress performance results for a baseline (negative control) specimen. FIG. 24B shows tensile stress performance results for a VACNT-reinforced specimen.

FIGS. 25A-25B are photographs of test specimens after failure condition. FIG. 25A shows baseline specimen; FIG. 25B shows VACNT-reinforced specimen.

FIG. 26 depicts the test results for cyclic testing (Cryo) in which one baseline and VACNT-reinforced open-hole specimen for each was cycled five times from 0 percent to 70 percent of ultimate tensile strength (UTS) at −320° F. in order to induce microcracking inside the specimens.

FIG. 27 is a graph of the test results for in-plane shear (Cryo) in the stress-strain behavior.

FIGS. 28A-28B depict the test results for in-plane shear (Cryo) in the stress strain behavior. FIG. 28A shows in-plane shear performance results for a baseline (negative control) specimen. FIG. 28B shows in-plane shear performance results for a VACNT-reinforced specimen. Strain was calculated by cross-head displacement. In these tests, the baseline and VACNT-reinforced specimens show similar shear modulus and shear strength properties.

FIGS. 29A-29B are photographs of test specimens after failure condition. FIG. 29A shows baseline specimen; FIG. 29B shows VACNT-reinforced specimen.

FIGS. 30A-30B depict the test results for in-plane shear (RT) in failure behavior. FIG. 30A shows in-plane shear performance results for a baseline (negative control) specimen. FIG. 30B shows in-plane shear performance results for a VACNT-reinforced specimen. Strain was calculated by cross-head displacement. In these tests, the baseline and VACNT-reinforced specimens show similar shear modulus and shear strength properties.

FIGS. 31A-31B are photographs of test specimens after failure condition. FIG. 31A shows baseline specimen; FIG. 31B shows VACNT-reinforced specimen.

FIG. 32 is an illustrative 2-dimensional schematic of a cross section of a [+45/90/-45/0]_{2S}16-ply embodiment of a composition of the present disclosure having VACNTs interdisposed between each pair of plies, and having a horizontally-aligned carbon nanotube (HACNT) layer interdisposed at the midplane (i.e., between the 8th and 9th ply of the 16 plies) of the laminate.

FIG. 33A-33B are scanning electron microscopy images. FIG. 33A shows VACNTs after mechanically rolling, rendering them substantially horizontally aligned HACNTs. FIG. 33B shows HACNTs applied to a surface of carbon-fiber fabric preimpregnated with epoxy resin.

### DETAILED DESCRIPTION

The following Detailed Description refers to accompanying drawings to illustrate exemplary embodiments consistent with the present disclosure. References in the Detailed Description to “one embodiment,” “an embodiment,” “an exemplary embodiment,” etc., indicate that the exemplary embodiment described can include a particular feature, structure, or characteristic, but every exemplary embodiment does not necessarily include the particular feature, structure, or characteristic. Moreover, such phrases are not necessarily referring to the same embodiment. Further, when a particular feature, structure, or characteristic is described in connection with an embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other embodiments are possible, and modifications can be made to exemplary embodiments within the scope of the present disclosure. Therefore, the Detailed Description is not meant to limit the present disclosure. Rather, the scope of the present disclosure is defined only in accordance with the following claims and their equivalents.

The present disclosure provides microcrack-resistant materials, apparatus for containing cryogenic fluid, and methods of containing cryogenic fluid.

Carbon-fiber composite materials offer significant weight-reduction advantages over other materials. However, when exposed to very cold temperatures, traditional composite materials suffer from microcrack initiation and propagation, as well as delamination. The phenomenon of cryogenic-cycling in which the composite structure is subjected to room temperature and cryogenic temperature alternately, can lead to progressive damage. In fiber-reinforced composites, thermal stresses develop at cryogenic temperature, which causes microcrack initiation and propagation. Thermal stresses develop because of the difference in thermal expansion of the fiber and matrix materials at microscale, and also due to the difference in thermal expansion of adjacent layers of the laminate.

For next-generation spaceflight vehicles to be affordable, it is important that their structural mass be reduced, thereby reducing the cost of launching payloads. Typically, gas storage tanks account for around half the dry weight of a spaceflight vehicle. Lightweight composite materials would offer numerous advantages over, e.g., metallic tanks if cryogenic microcrack and delamination problems could be overcome. Other fields would similarly benefit from lightweight composite materials resistant to cryogenic microcracking and delamination.

Composite cryogenic storage tanks are available. However, currently available carbon/epoxy-based cryogenic storage tanks still are prone to microcracking, which may lead to reduced structural integrity and increased permeability, resulting in leakage of the contents of the tank. For many years, use of metallic liners has been the predominant strategy for reducing fluid permeation in composite cryogenic storage tanks. However, significant mismatch between the coefficient of thermal expansion (CTE) of the metal and the composite material's polymer matrix tends to result in debonding of the metallic liner from the tank, which in turn leads to excessive fluid permeation. Metallic liners are also heavy and can be difficult to manufacture and maintain. Polymeric liners have also been used, but still present significant drawbacks including CTE-mismatch.

Accordingly, there is significant unmet need for composite material resistant to microcracking caused by cryocycling, and which is remains impermeable to its fluid (e.g., gas) contents even after many room-temperature/cryogenic thermocycles as well as pressurization/depressurization cycles.

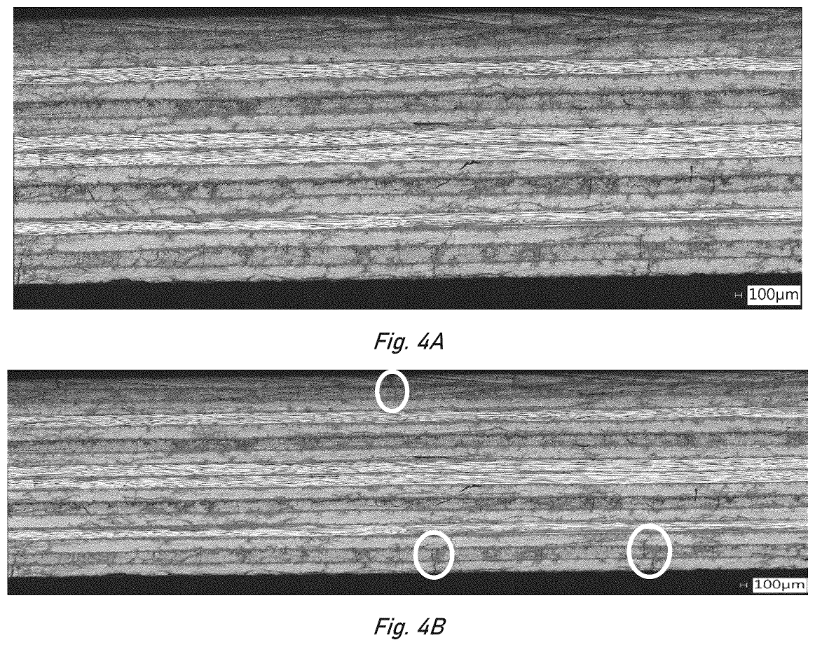

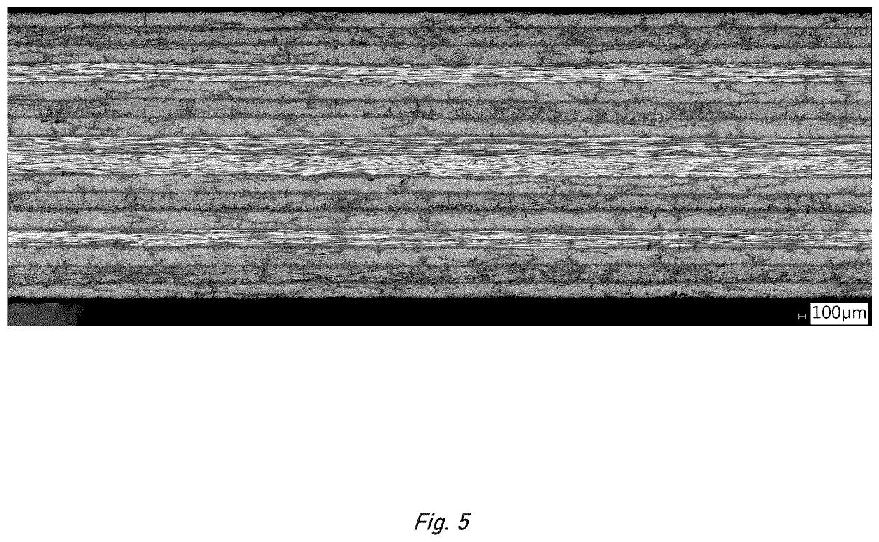

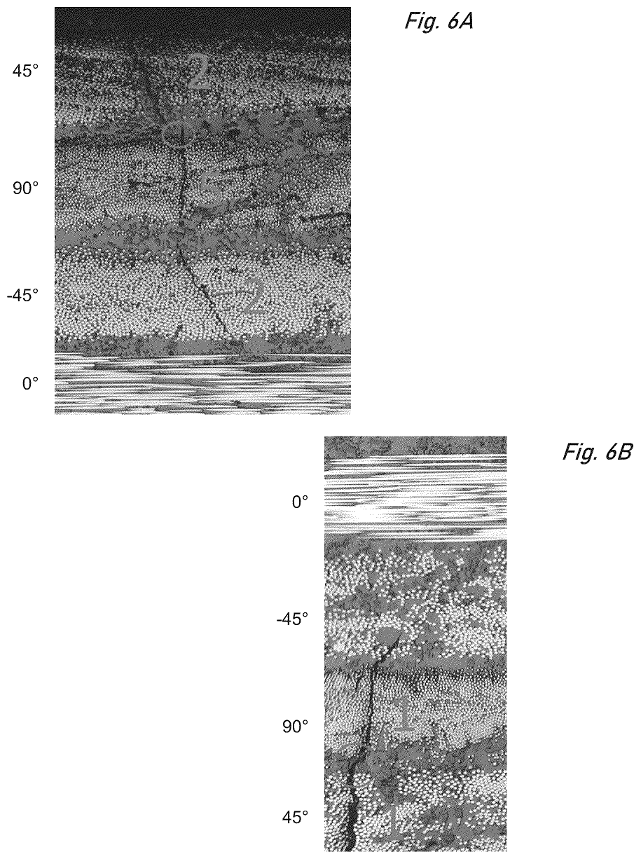

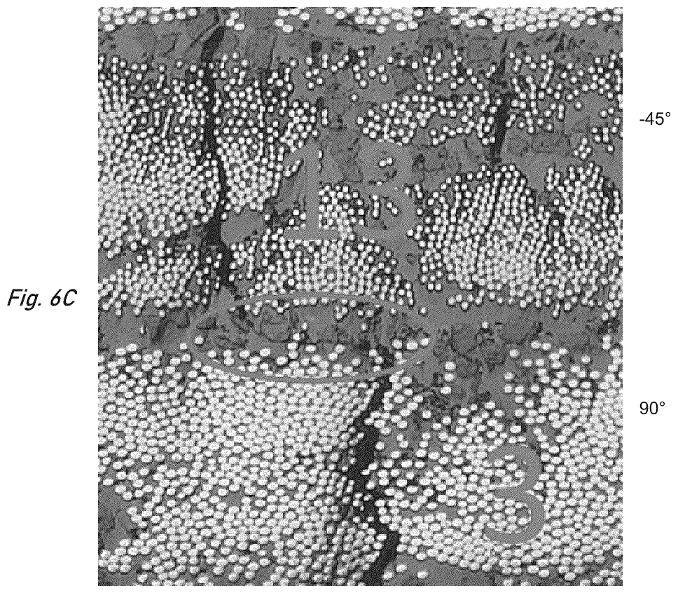

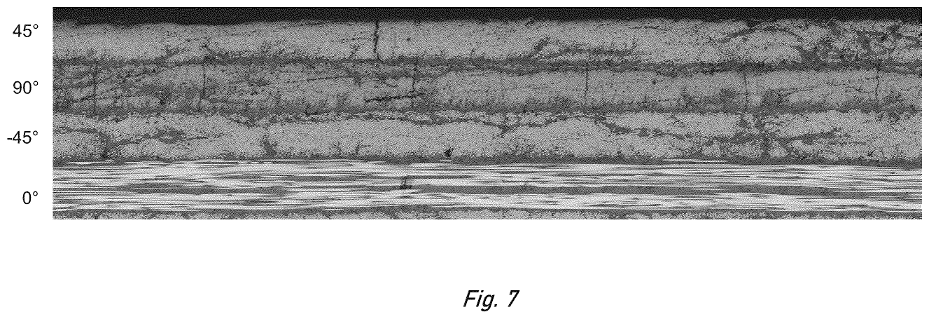

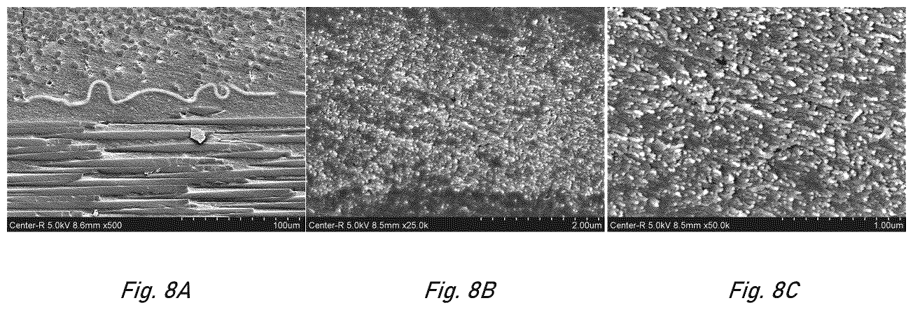

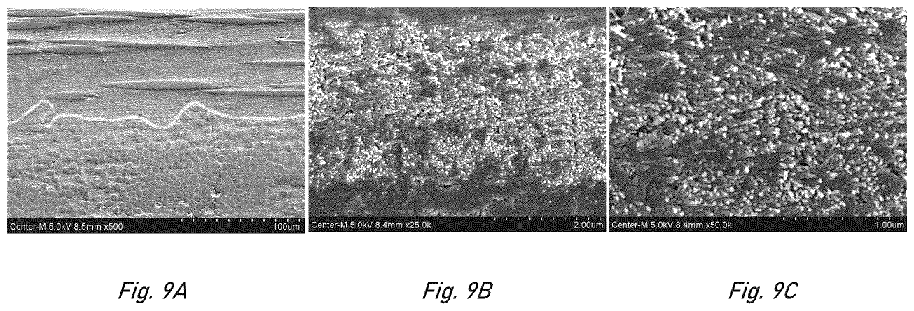

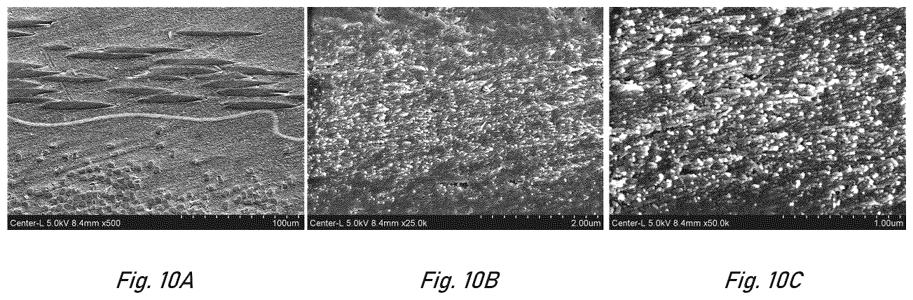

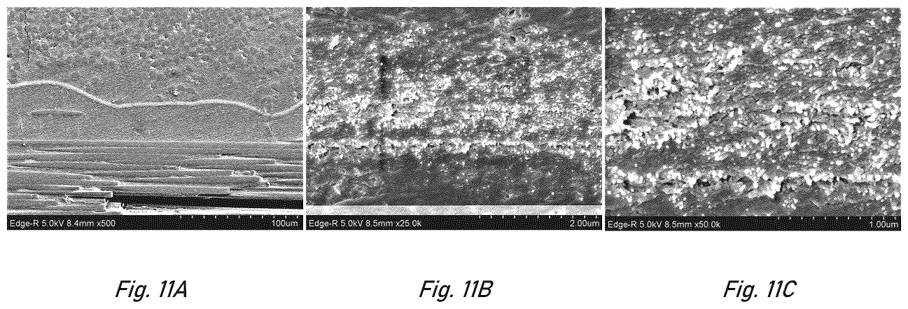

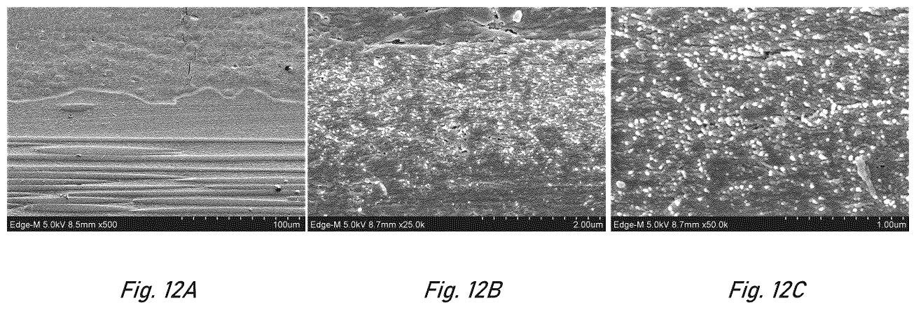

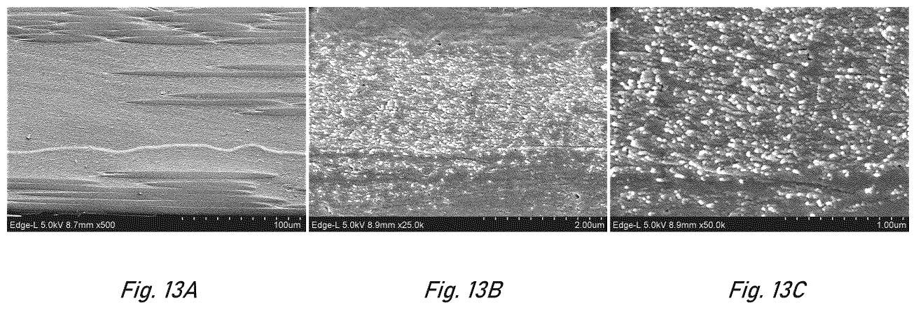

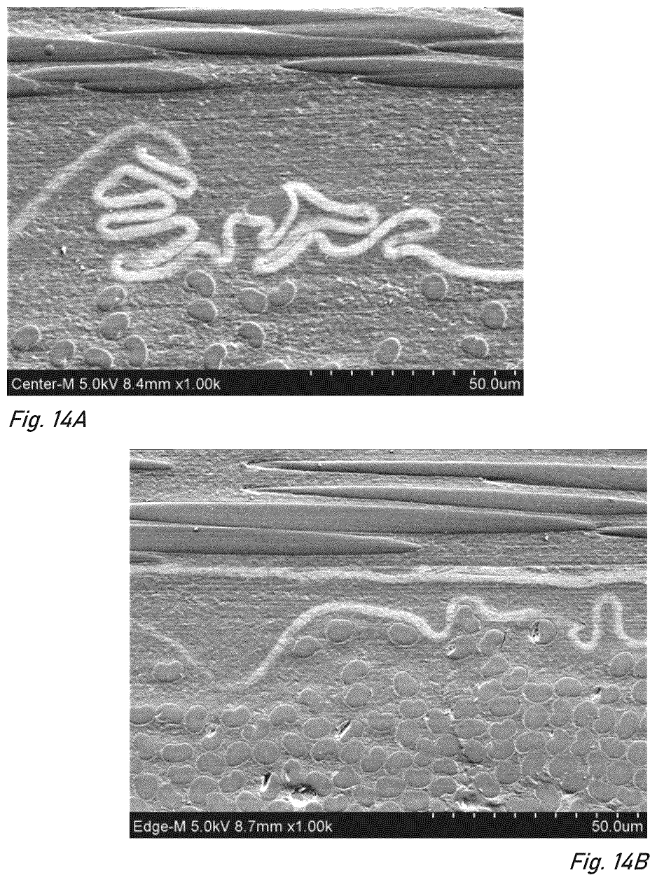

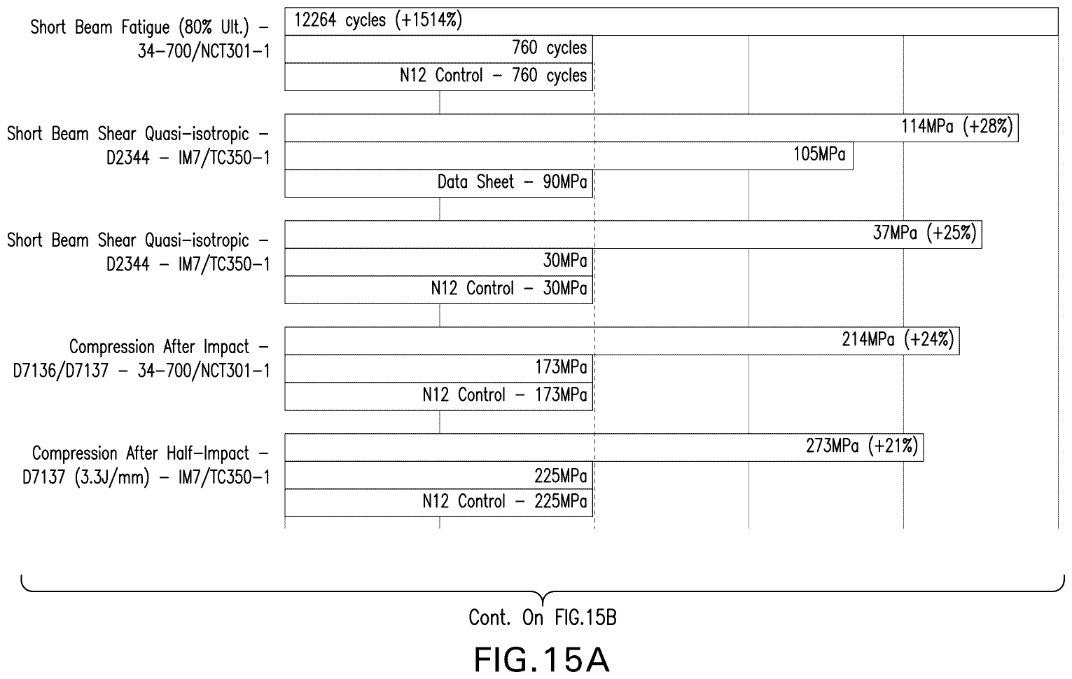

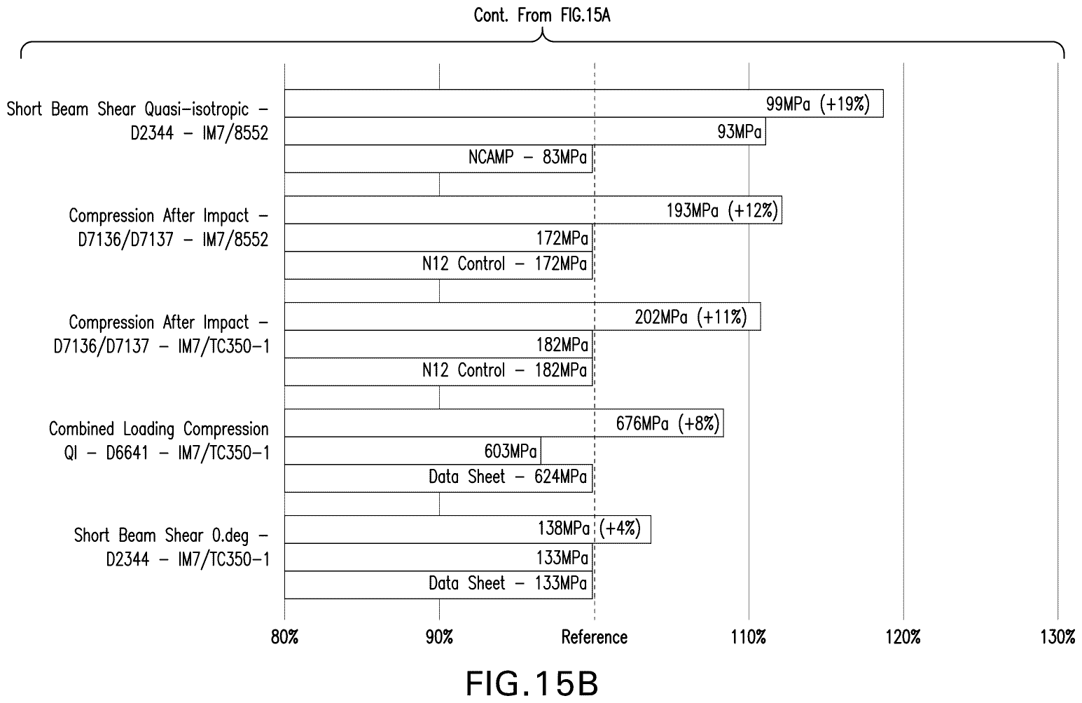

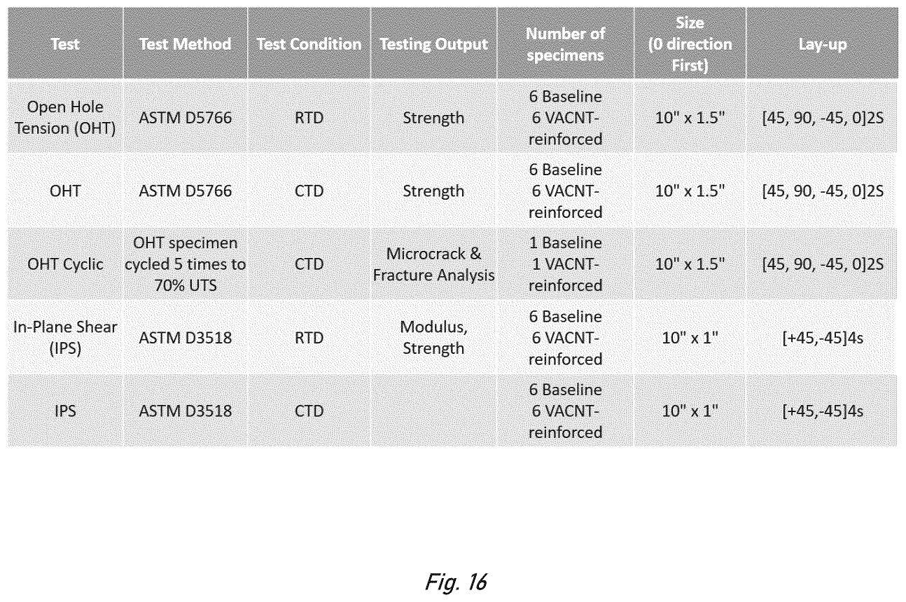

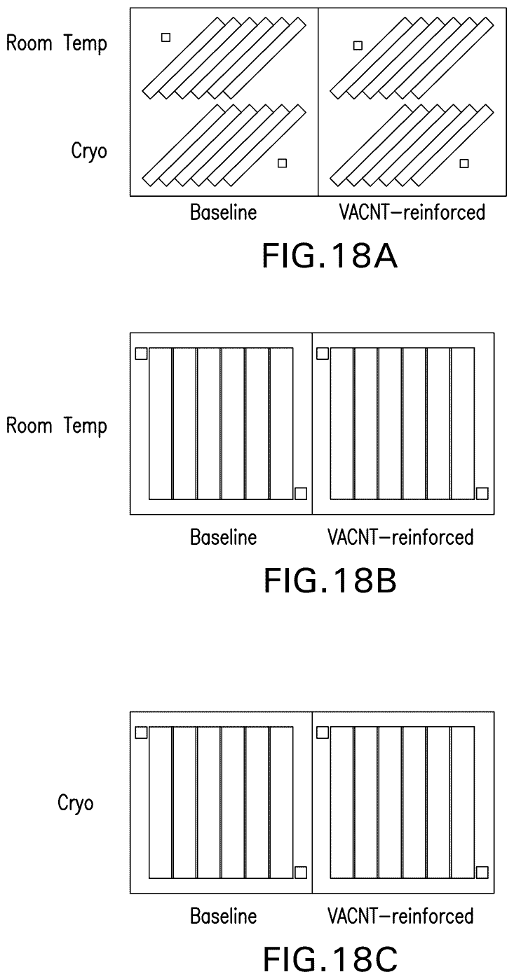

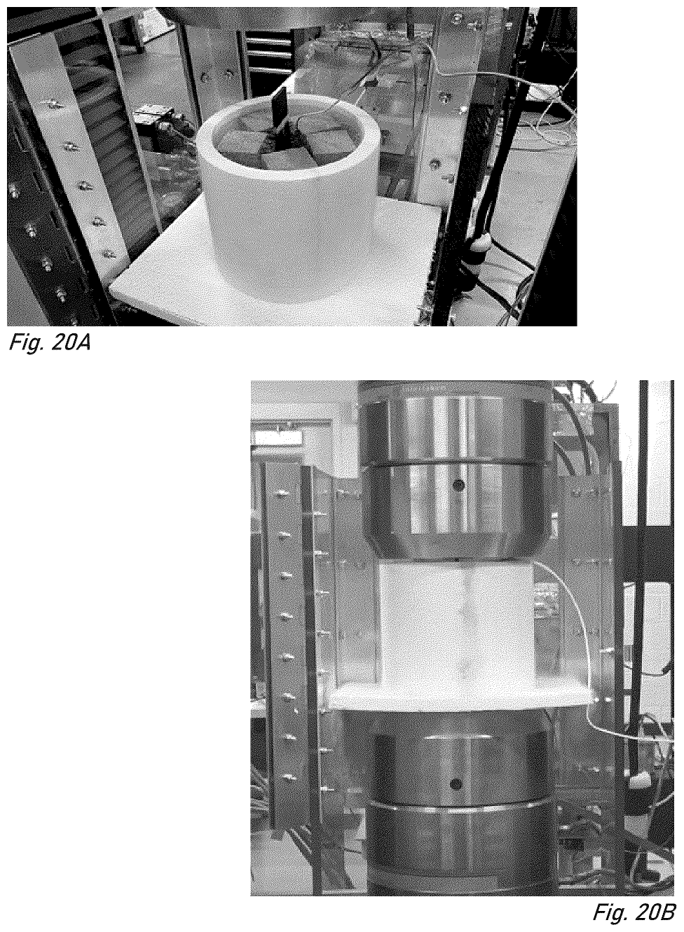

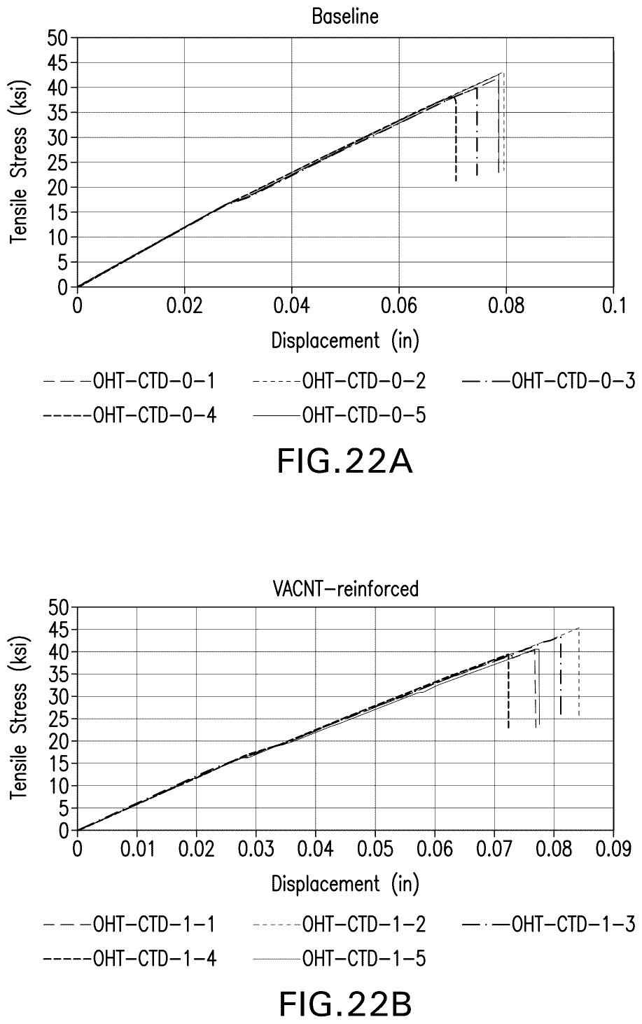

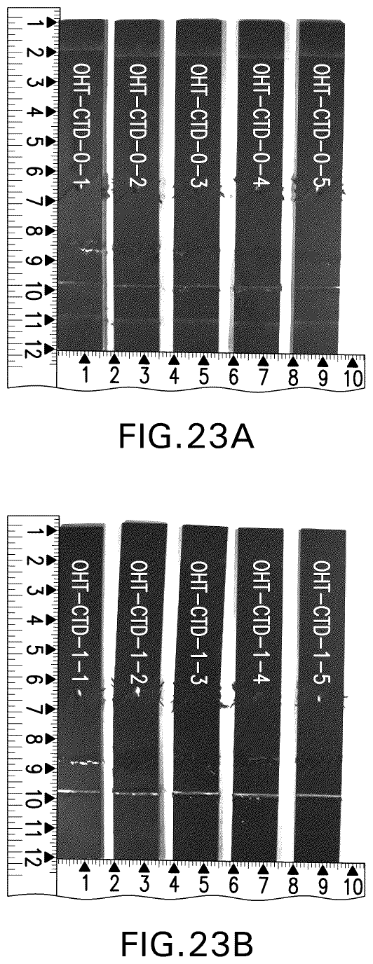

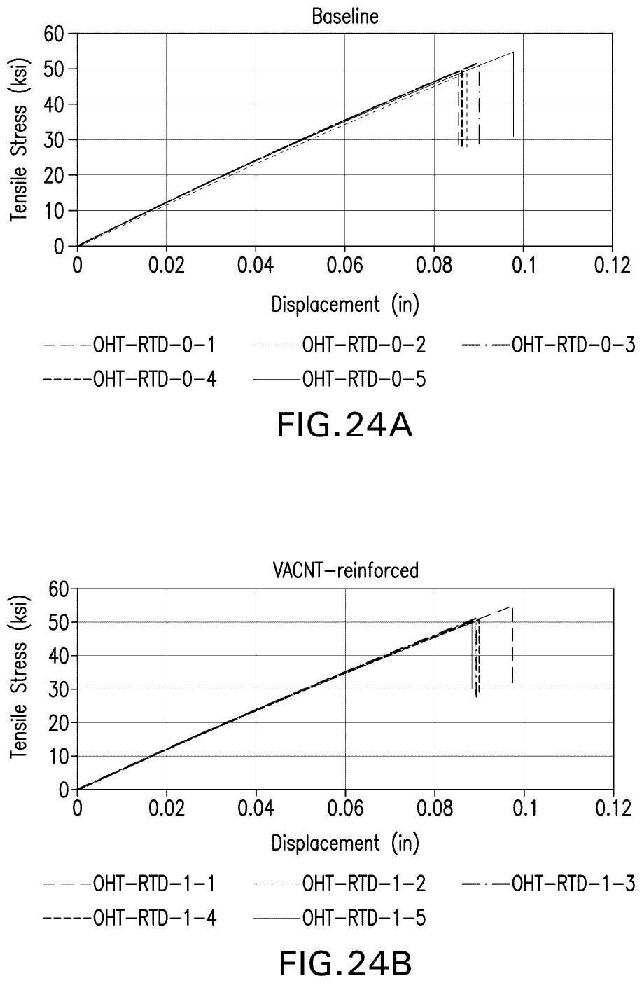

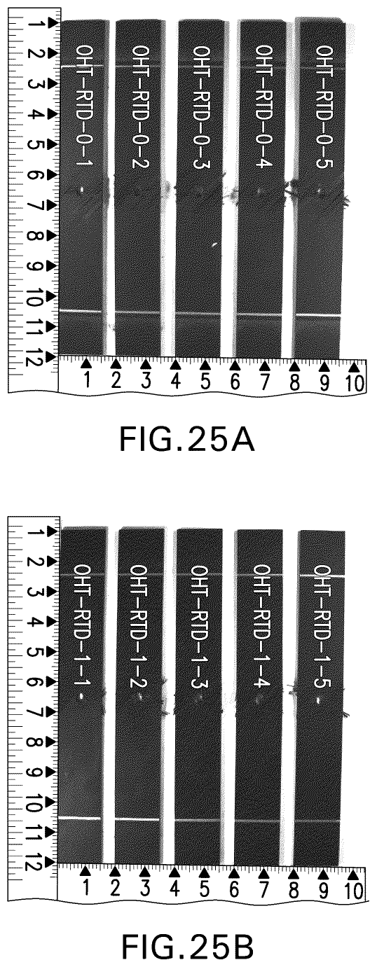

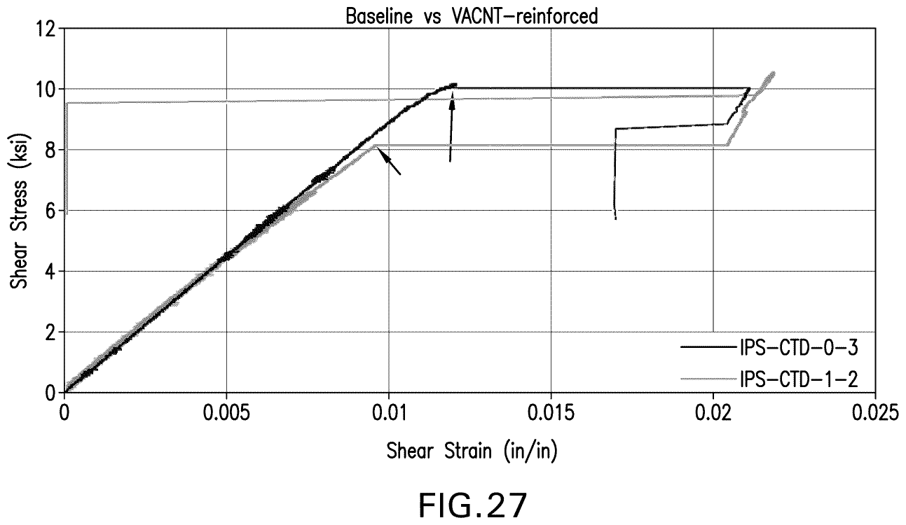

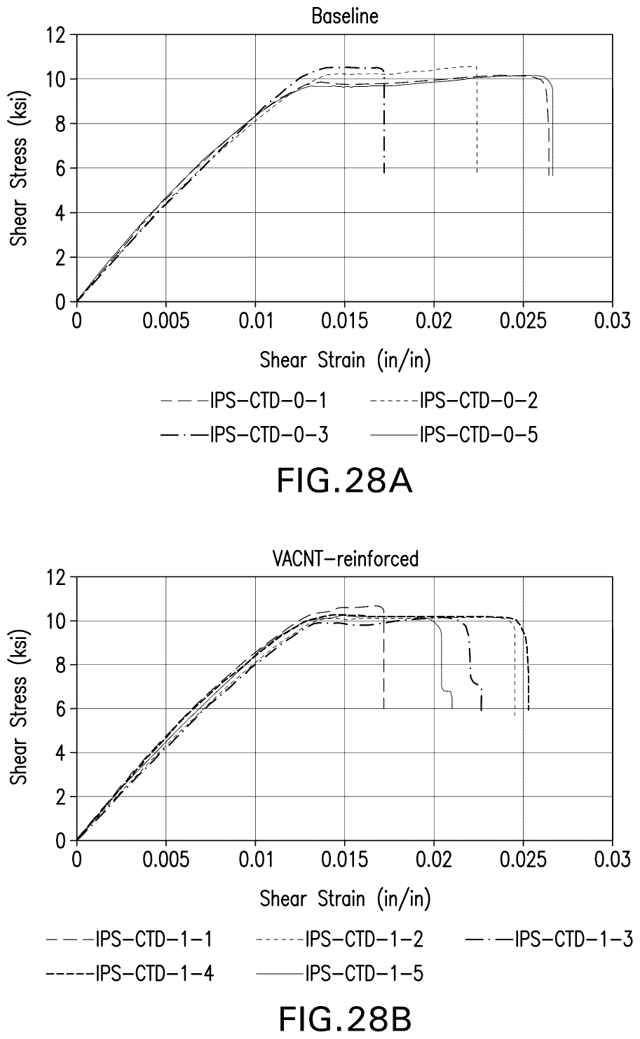

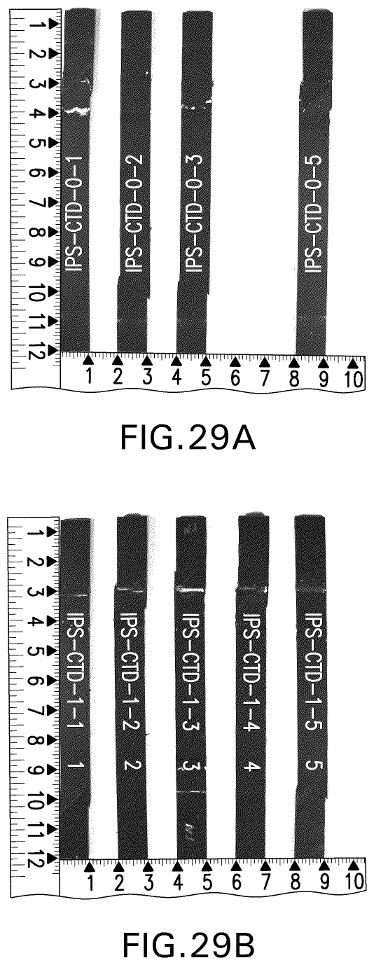

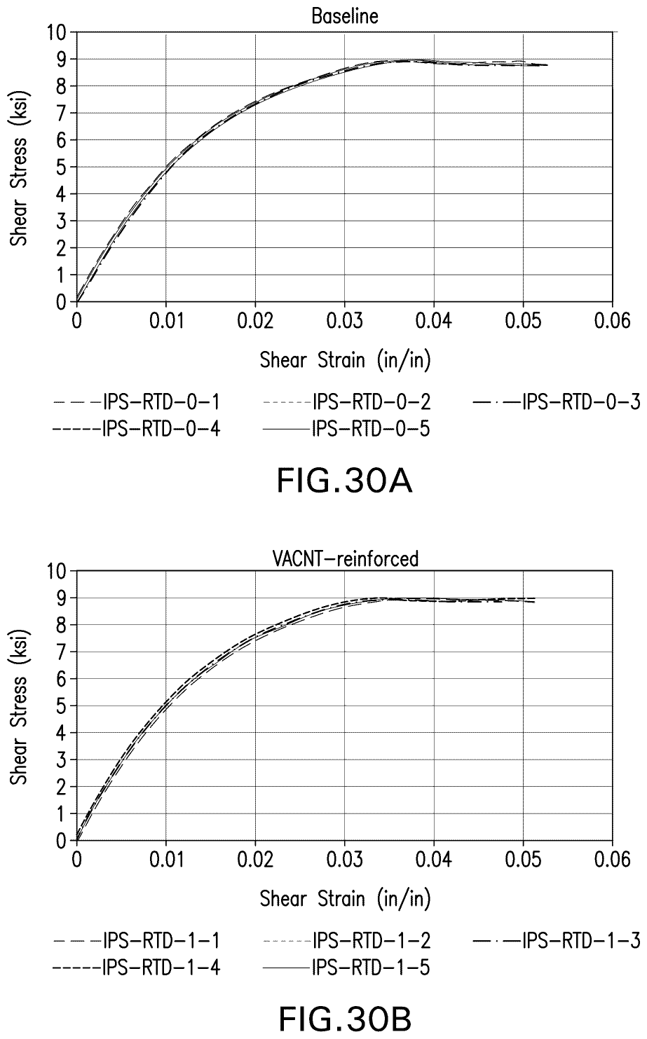

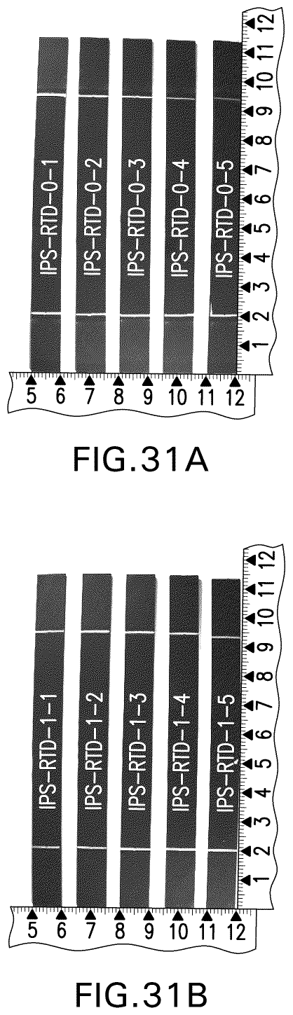

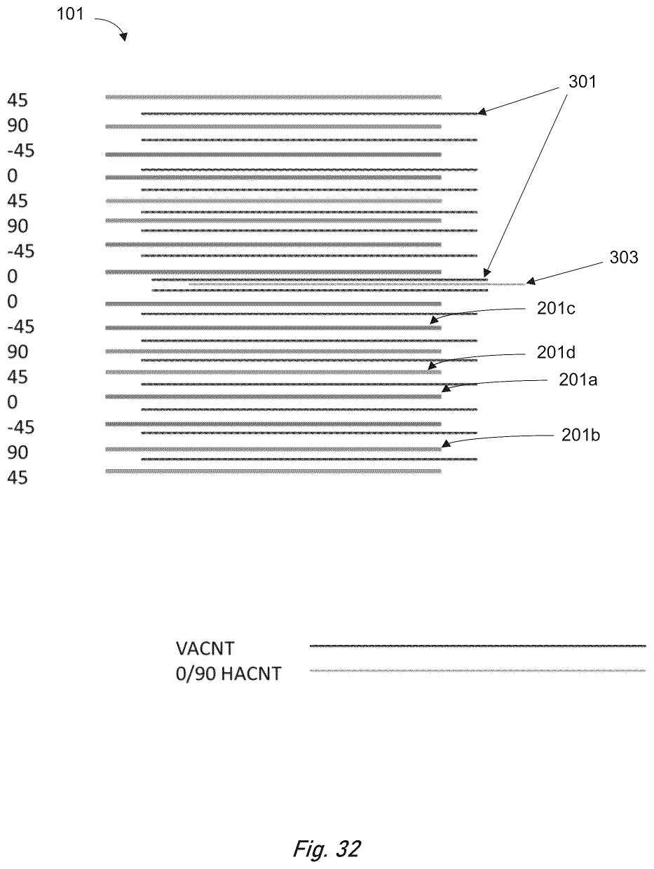

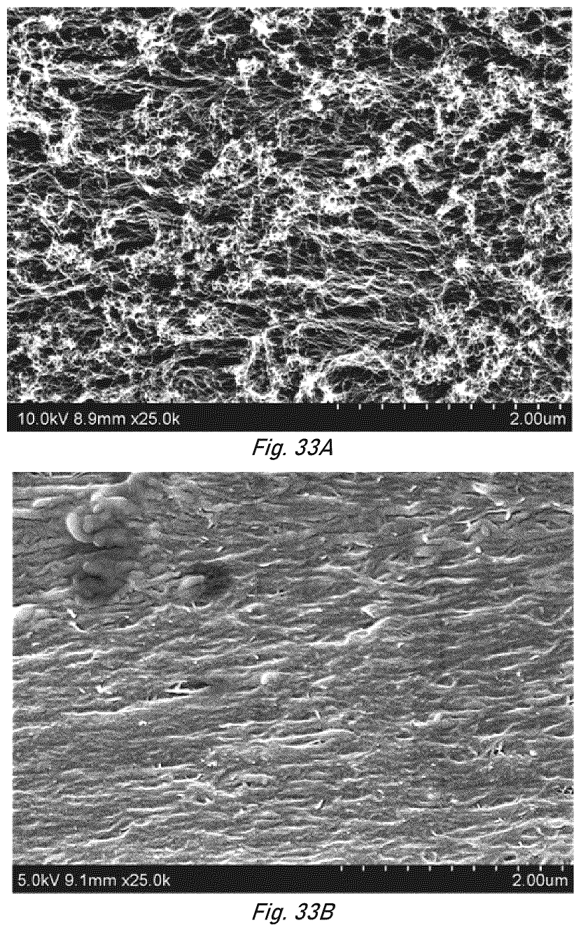

In an aspect, the present disclosure provides a microcrack-resistant laminate composition comprising: at least two plies, each ply comprising carbon-fiber fabric impregnated with resin; and interdisposed between each pair of plies, a substantially aligned aggregate of carbon nanotubes oriented substantially orthogonally to the plies. Such orthogonal vertically-aligned carbon nanotubes (VACNTs) interdisposed between plies (see, e.g., FIG. 3) improve delamination and sheer stress and torsion performance over ordinary “baseline” composite materials. (See FIGS. 15-31.) It has been shown that the composition of the present disclosure is resistant to microcracking after cryocycling. Compositions of the present disclosure developed fewer microcracks than baseline materials, and, crucially, compositions of the present disclosure developed zero microcracks which propagate through multiple laminate ply layers (Compare FIG. 4B with FIG. 5). The composition of the present disclosure demonstrated about 20 percent lower microcracking in 90-degree oriented plies than baseline material; and about 50 percent lower microcracking 45-degree oriented plies than baseline material. (See microcrack test data in FIGS. 4-7, and Table 1, infra (test embodiment with [+45/90/−45/0]_{2S} ply orientation formula).)

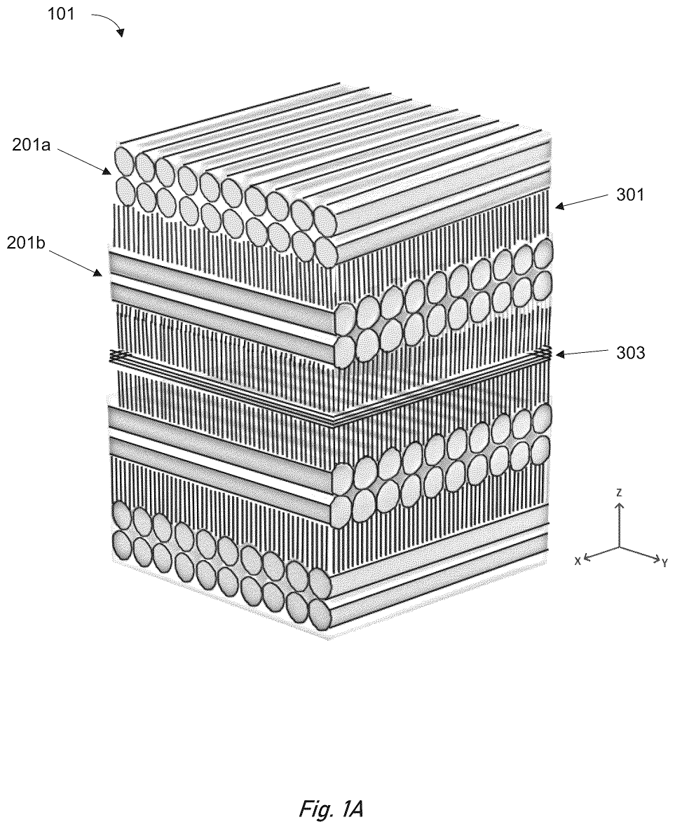

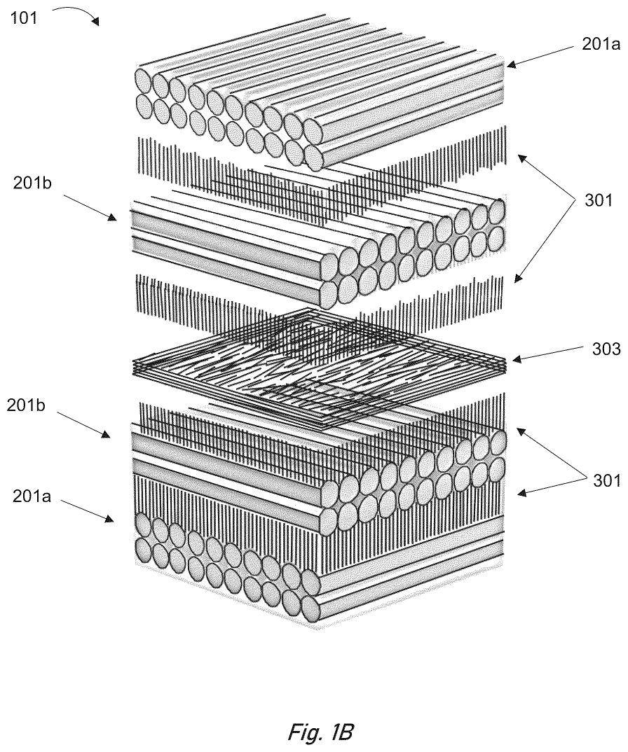

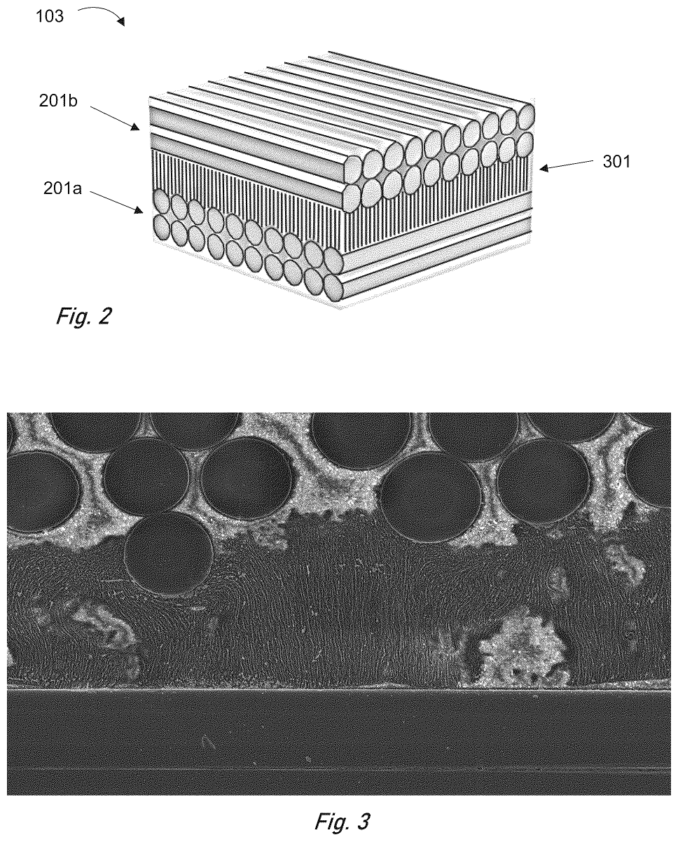

Turning to FIGS. 1A-1B, FIG. 1A provides an exemplary perspective view of a square-columnar section of a composition 101 of the present invention. FIG. 1B provides a partially exploded representation of the composition of FIG. 1A. The ply orientation formula of the exemplary embodiment is [0/90]s. A 0-degree ply 201a and a 90-degree ply 201b are interdisposed with a forest of vertically-aligned carbon nanotubes 301. At the midplane, a layer of horizontally-aligned carbon nanotubes 303 is sandwiched between layers of vertically-aligned carbon nanotubes. It should be appreciated that FIGS. 1A-1B are not shown to scale, and the elements shown only for illustrative purposes. (For example, the forest of vertically-aligned carbon nanotubes, as shown in FIG. 1B, are depicted only at the edge vertices, for illustrative purposes only.) The layer horizontal-aligned nanotubes 303 generally would be laid up in either a 0° or a 900 orientation. FIG. 2 shows an example of a pair 103 of 0/90 plies, i.e., having a 0-degree ply 201a and a 90-degree ply 201b, interdisposed with a forest of vertically aligned carbon nanotubes 301.

In any embodiment of the microcrack-resistant laminate composition may comprise interdisposed between at least one pair of plies or disposed on an outer surface of an outmost ply, a layer comprising an aggregate of substantially aligned carbon nanotubes oriented substantially horizontally to the plies. The carbon nanotubes of the present disclosure may be single-walled, double-walled, branched, or unbranched. In any embodiment, the composition may comprise a layer comprising an aggregate of substantially aligned carbon nanotubes oriented substantially horizontally to the plies interdisposed between at least one pair of plies, disposed on an outer surface of an outmost ply, or may comprise layers comprising an aggregate of substantially aligned carbon nanotubes oriented substantially horizontally to the plies interdisposed between at least one pair of plies and disposed on an outer surface of an outmost ply. In any embodiment, the composition may comprise a layer of carbon nanotubes oriented substantially horizontally to the plies interdisposed at a midplane of the laminate. In any embodiment, the horizontal carbon nanotubes may be substantially aligned relative to one another. The horizontal carbon nanotubes may be oriented substantially parallel to one another.

As used herein, “horizontally” refers to any orientation which is about 90° from the orthogonal Z-axis, relative to the laminate composition. At any given point on the composition, the Z-axis should be understood as referring to the direction of layer stacking. (FIG. 1A.) The orientation frame-of-reference should be understood relative to the surface of a composition. Accordingly, it should be appreciated that “horizontally”, as used herein, is not dependent on a viewer's orientation, not dependent on the overall orientation of a specimen of the present composition or an object comprising the present composition, and is not relative to earth's horizon. A feature of the composition may be oriented “horizontally” notwithstanding the presence of curved surfaces (e.g., in forming the composition into a shell of a fluid tank), or due to rotating the orientation of the composition relative to an observer.

Horizontally aligned carbon nanotubes (HACNTs) may be produced by depositing vertically aligned carbon nanotubes (VACNTs) on a surface followed by mechanically rolling and flattening VACNTs, e.g., using any suitable roller instrument.

As used herein, a “forest” of carbon nanotubes refers to a substantially aligned aggregate of carbon nanotubes that is substantially orthogonal to a substrate.

Vertically aligned carbon nanotubes (VACNTs) of the composition may be 5 to 100 microns in length. VACNTs of the composition may be 10 to 50 microns in length. VACNTs of the composition may be 15 to 40 microns in length. VACNTs may be 15 microns, 18 microns, 21 microns, 24 microns, 27 microns, 30 microns, 33 microns, 36 microns in length.

Horizontally aligned carbon nanotubes (HACNTs) of the composition may be 5 to 3000 microns in length. HACNTs of the composition may be 5 to 2950 microns in length, 5 to 2900 microns in length, 5 to 2850 microns in length, 5 to 2800 microns in length, 5 to 2750 microns in length, 5 to 2700 microns in length, 5 to 2650 microns in length, 5 to 2600 microns in length, 5 to 2550 microns in length, 5 to 2500 microns in length, 5 to 2450 microns in length, 5 to 2400 microns in length, 5 to 2350 microns in length, 5 to 2300 microns in length, 5 to 2250 microns in length, 5 to 2200 microns in length, 5 to 2150 microns in length, 5 to 2100 microns in length, 5 to 2050 microns in length, 5 to 2000 microns in length, 5 to 1950 microns in length, 5 to 1900 microns in length, 5 to 1850 microns in length, 5 to 1800 microns in length, 5 to 1750 microns in length, 5 to 1700 microns in length, 5 to 1650 microns in length, 5 to 1600 microns in length, 5 to 1550 microns in length, 5 to 1500 microns in length, 5 to 1450 microns in length, 5 to 1400 microns in length, 5 to 1350 microns in length, 5 to 1300 microns in length, 5 to 1250 microns in length, 5 to 1200 microns in length, 5 to 1150 microns in length, 5 to 1100 microns in length, 5 to 1050 microns in length, 5 to 1000 microns in length, 5 to 950 microns in length, 5 to 900 microns in length, 5 to 850 microns in length, 5 to 800 microns in length, 5 to 750 microns in length, 5 to 700 microns in length, 5 to 650 microns in length, 5 to 600 microns in length, 5 to 550 microns in length, 5 to 500 microns in length, 5 to 450 microns in length, 5 to 400 microns in length, 5 to 350 microns in length, 5 to 300 microns in length, 5 to 250 microns in length, 5 to 200 microns in length, 5 to 150 microns in length, 5 to 100 microns in length, 5 to 90 microns in length, 5 to 80 microns in length, 5 to 70 microns in length, 5 to 60 microns in length, 5 to 50 microns in length, 5 to 40 microns in length, or 5 to 30 microns in length. HACNTs of the composition may be 10 to 3000 microns in length, 15 to 3000 microns in length, 20 to 3000 microns in length, 25 to 3000 microns in length, 30 to 3000 microns in length, 35 to 3000 microns in length, 40 to 3000 microns in length, 45 to 3000 microns in length, 50 to 3000 microns in length, 55 to 3000 microns in length, 60 to 3000 microns in length, 65 to 3000 microns in length, 70 to 3000 microns in length, 75 to 3000 microns in length, 80 to 3000 microns in length, 85 to 3000 microns in length, 90 to 3000 microns in length, 95 to 3000 microns in length, 100 to 3000 microns in length, 105 to 3000 microns in length, 110 to 3000 microns in length, 115 to 3000 microns in length, 120 to 3000 microns in length, 125 to 3000 microns in length, 130 to 3000 microns in length, 135 to 3000 microns in length, 140 to 3000 microns in length, 145 to 3000 microns in length, 150 to 3000 microns in length, 155 to 3000 microns in length, 160 to 3000 microns in length, 165 to 3000 microns in length, 170 to 3000 microns in length, 175 to 3000 microns in length, 180 to 3000 microns in length, 185 to 3000 microns in length, 190 to 3000 microns in length, 195 to 3000 microns in length, 200 to 3000 microns in length, 205 to 3000 microns in length, 210 to 3000 microns in length, 215 to 3000 microns in length, 220 to 3000 microns in length, 225 to 3000 microns in length, 230 to 3000 microns in length, 235 to 3000 microns in length, 240 to 3000 microns in length, 245 to 3000 microns in length, 250 to 3000 microns in length. In any embodiment, the HACNTs may be 250 to 2500 microns in length.

The fabric comprising the layers of the composition of the present disclosure may be of any suitable fiber type and diameter. Non-limiting examples include HTS40 with diameter of 7 microns, and IMS65 with diameter of 5 microns. Fiber areal weight (FAW) may vary from 140gsm as a commercial baseline to 50-75gsm. The fabrics may be impregnated with any suitable resin material. Non-limiting examples include Teijin Q183 epoxy resin.

The composition may have any suitable ply orientation. In any embodiment, the laminate may be quasi-isotropic. In any embodiment, the ply orientation formula (also sometimes called “stacking sequence”) may be symmetric. The composition may comprise any suitable number of plies provided there are at least two plies. In any embodiment, the composition may comprise at least four plies. The composition may comprise two plies, four plies, six plies, eight plies, 10 plies, 12 plies, 14 plies, 16 plies, 18 plies, 20 plies, 22 plies, 24 plies, 26 plies, 28 plies, 30 plies, 32 plies, or even more. In any embodiment, the composition may comprise 16 plies. In any embodiment, the composition may have a ply orientation formula selected from the group consisting of: [+45/-30/0]ₛ; [+45/-30/0]_{2S}; [0/90]_{4S}; [0/90]_{2S}; In any embodiment, the composition may have a ply orientation formula of [0/90]_{4S}. In any embodiment, the composition may have a ply orientation formula of [+45/90/-45/0]_{2S}.

In any embodiment, the resin may be a thermoplastic resin. In any embodiment, the resin may be thermosetting resin. In such embodiments, the thermosetting resin may cure at any temperature from about 20° C. to about 300° C. The thermosetting resin may cure at about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., about 200° C., about 205° C., about 210° C., about 215° C., about 220° C., about 225° C., about 230° C., about 235° C., about 240° C., about 245° C., about 250° C., about 255° C., about 260° C., about 265° C., about 270° C., about 275° C., about 280° C., about 285° C., about 290° C., about 295° C., or about 300° C., or even higher. In any embodiment, the thermosetting resin may cure at 160° C. In is should be understood that the cure temperature or melting temperature depends on the specific polymer being used.

In any embodiment, the carbon-fiber fabric may be unidirectional. In any embodiment, the carbon-fiber fabric may be plain woven, or any weave.

In another aspect, the present disclosure provides a microcrack-resistant fluid tank comprising: a tank shell forming an internal volume configured to receive and contain cryogenic fluid, the tank shell comprising a carbon-fiber laminate comprising at least four plies, each ply comprising a carbon-fiber fabric impregnated with resin, between each pair of plies is a forest of carbon-nanotubes orthogonal to the plies, and between at least one pair of plies or on an inner surface of the tank shell is a layer of carbon nanotubes oriented substantially horizontally to the plies. In any embodiment of the fluid tank, the carbon-fiber laminate may comprise 16 plies. In any embodiment, the resin may be thermosetting resin.

The fluid tank shell may be, without limitation, a shape selected from: spherical, substantially spherical, hemispherical, spheroid, hemispheroid, torus, toroid, cylindrical or substantially cylindrical, barrel shaped, corpuscle shaped, corrugated, domed, ellipsoid, ovoid, semiellipsoid, semiovoid, paraboloid, hyperboloid, prolate, stellate, tetrahedral, octahedral, or helical. The fluid tank may be configured, for example, to fit in a space vehicle, airplane wing, or motor vehicle chassis.

In any embodiment, there may be, interdisposed in an area between the pair of plies forming a midplane, a layer of carbon nanotubes oriented substantially horizontally to the plies. In any embodiment, the tank may comprise on an inner surface of the tank shell a layer of carbon nanotubes oriented substantially horizontally to the plies.

In any embodiment of the fluid tank, microcracks do not propagate between plies when the tank shell is thermocycled at least five times between room temperature and a temperature under about 20 kelvins. In any embodiment of the tank, microcracks do not propagate between plies when the tank shell is thermocycled at least five times between room temperature and a temperature under about 77 kelvins. In any embodiment of the tank, microcracks do not propagate between plies after prolonged exposure of the tank shell to any temperatures between 1 kelvin to 133 kelvins. In any embodiment of the tank, microcracks do not propagate between plies after prolonged exposure of the tank shell to any temperatures between 4 kelvin to 111 kelvins. In any embodiment of the tank, microcracks do not propagate between plies after prolonged exposure of the tank shell to any temperatures between 10 kelvin to 80 kelvins. In any embodiment of the tank, microcracks do not propagate between plies after prolonged exposure of the tank shell to any temperatures between 15 kelvin to 20 kelvins. In any embodiment of the tank, microcracks do not propagate between plies after prolonged exposure of the tank shell to any temperatures between 50 kelvin to 80 kelvins. In any embodiment of the tank, microcracks do not propagate between plies after prolonged exposure of the tank shell to any temperatures between 55 kelvin to 70 kelvins. In any embodiment of the tank, microcracks do not propagate between plies after prolonged exposure of the tank shell to any temperatures between 55 kelvin to 77 kelvins. In any embodiment of the tank, the number of microcracks that form upon exposure to 77 kelvins is at least 20 percent lower than the number of microcracks that form upon exposure of a comparable tank lacking VACNTs interdisposed between carbon-fiber fabric layers.

In any embodiment of the fluid tank, the tank may receive and contain cryogenic fluid without microcracks propagating between plies.

In still another aspect, the present disclosure provides a method of containing cryogenic fluid without leaks, the method comprising: filling a tank with a cryogenic fluid, the tank comprising a tank shell forming an internal volume configured to receive and contain the cryogenic fluid, the tank shell comprising a carbon-fiber laminate comprising at least four plies, each ply comprising a carbon-fiber fabric impregnated with resin, wherein interdisposed between each pair of plies is a forest of carbon-nanotubes orthogonal to the plies, and wherein interdisposed between at least one pair of plies or disposed on in inner surface of the tank shell is a layer of carbon nanotubes oriented substantially horizontally to the plies; and retaining the cryogenic fluid inside the tank. In any embodiment, the resin may be thermosetting resin.

In any embodiment of the method, the cryogenic fluid may be liquid hydrogen. In any embodiment, the cryogenic fluid may be any of, e.g., liquid helium, liquid hydrogen, liquid oxygen, liquid nitrogen, liquid natural gas, liquid argon, liquid methane, or liquid carbon monoxide.

In any embodiment of the method, the cryogenic fluid may have a permeability through the tank shell of less than 1×10⁻¹⁸ mol/s/m/Pa at a cryogenic temperature. In any embodiment, the cryogenic fluid may have, at cryogenic temperature, a permeability through the tank shell of less than 5×10−19 mol/s/m/Pa, less than 1×10−19 mol/s/m/Pa, less than 5×10⁻²⁰ mol/s/m/Pa, less than 1×10⁻²⁰ mol/s/m/Pa, less than 5×10⁻²¹ mol/s/m/Pa, less than 1×10⁻²¹ mol/s/m/Pa, or even lower. In any embodiment of the method, the cryogenic temperature may be about 77 kelvins.

The present disclosure may be further understood by reference to the following clauses:
Clause 1. A microcrack-resistant laminate composition comprising: at least two plies, each ply comprising carbon-fiber fabric impregnated with resin; and interdisposed between each pair of plies, a substantially aligned aggregate of carbon nanotubes oriented substantially orthogonally to the plies.
Clause 2. The microcrack-resistant laminate composition of clause 1, further comprising, interdisposed between at least one pair of plies or disposed on an outer surface of an outmost ply, a layer comprising an aggregate of substantially aligned carbon nanotubes oriented substantially horizontally to the plies.
Clause 3. The microcrack-resistant laminate composition of clause 1, having a ply orientation formula of [0/90]_{4S}.
Clause 4. The microcrack-resistant laminate composition of clause 1, having a ply orientation formula of [+45/90/-45/0]_{2S}.
Clause 5. The microcrack-resistant laminate composition of clause 2, wherein a layer of carbon nanotubes oriented substantially horizontally to the plies is interdisposed at a midplane of the laminate.
Clause 6. The microcrack-resistant laminate composition of clause 1, comprising at least four plies.
Clause 7. The microcrack-resistant laminate composition of clause 1, comprising 16 plies.
Clause 8. The microcrack-resistant laminate composition of clause 1, wherein the resin is a thermosetting resin that cures at about 160° C.
Clause 9. The microcrack-resistant laminate composition of clause 1, wherein the carbon-fiber fabric is unidirectional.
Clause 10. A microcrack-resistant fluid tank comprising: a tank shell forming an internal volume configured to receive and contain cryogenic fluid, the tank shell comprising a carbon-fiber laminate comprising at least four plies, each ply comprising a carbon-fiber fabric impregnated with resin, between each pair of plies is a forest of carbon-nanotubes orthogonal to the plies, and between at least one pair of plies or on an inner surface of the tank shell is a layer of carbon nanotubes oriented substantially horizontally to the plies.

Clause 11. The microcrack-resistant fluid tank of clause 10, wherein the carbon-fiber laminate comprises 16 plies.

Clause 12. The microcrack-resistant fluid tank of clause 10, wherein interdisposed in an area between the pair of plies forming a midplane is a layer of carbon nanotubes oriented substantially horizontally to the plies.

Clause 13. The microcrack-resistant fluid tank of clause 10, comprising on an inner surface of the tank shell a layer of carbon nanotubes oriented substantially horizontally to the plies.

Clause 14. The microcrack-resistant fluid tank of clause 10, wherein microcracks do not propagate between plies when the tank shell is thermocycled at least five times between room temperature and a temperature under about 20 kelvins.

Clause 15. The microcrack-resistant fluid tank of clause 10, wherein microcracks do not propagate between plies when the tank shell is thermocycled at least five times between room temperature and a temperature under about 77 kelvins.

Clause 16. The microcrack-resistant fluid tank of clause 10, wherein the tank receives and contains cryogenic fluid without microcracks propagating between plies.

Clause 17. The microcrack-resistant fluid tank of clause 16, wherein the cryogenic fluid is liquid hydrogen.

Clause 18. A method of containing cryogenic fluid without leaks, the method comprising: filling a tank with a cryogenic fluid, the tank comprising a tank shell forming an internal volume configured to receive and contain the cryogenic fluid, the tank shell comprising a carbon-fiber laminate comprising at least four plies, each ply comprising a carbon-fiber fabric impregnated with resin, wherein interdisposed between each pair of plies is a forest of carbon-nanotubes orthogonal to the plies, and wherein interdisposed between at least one pair of plies or disposed on in inner surface of the tank shell is a layer of carbon nanotubes oriented substantially horizontally to the plies; and retaining the cryogenic fluid inside the tank.

Clause 19. The method of clause 18, wherein the cryogenic fluid is liquid hydrogen.

Clause 20. The method of clause 18, wherein the cryogenic fluid has a permeability through the tank shell of less than 1×10⁻¹⁸ mol/s/m/Pa at a cryogenic temperature.

Clause 21. The method of clause 20, wherein the cryogenic temperature is about 77 kelvins.

Clause 22. The method of clause 20, wherein the cryogenic temperature is about 20 kelvins.

### EXAMPLES

The present disclosure may be further understood with reference to the following examples.

“Baseline” layups having no VACNTs were compared on strength, microcrack, modulus, and other properties with layups with VACNTs.

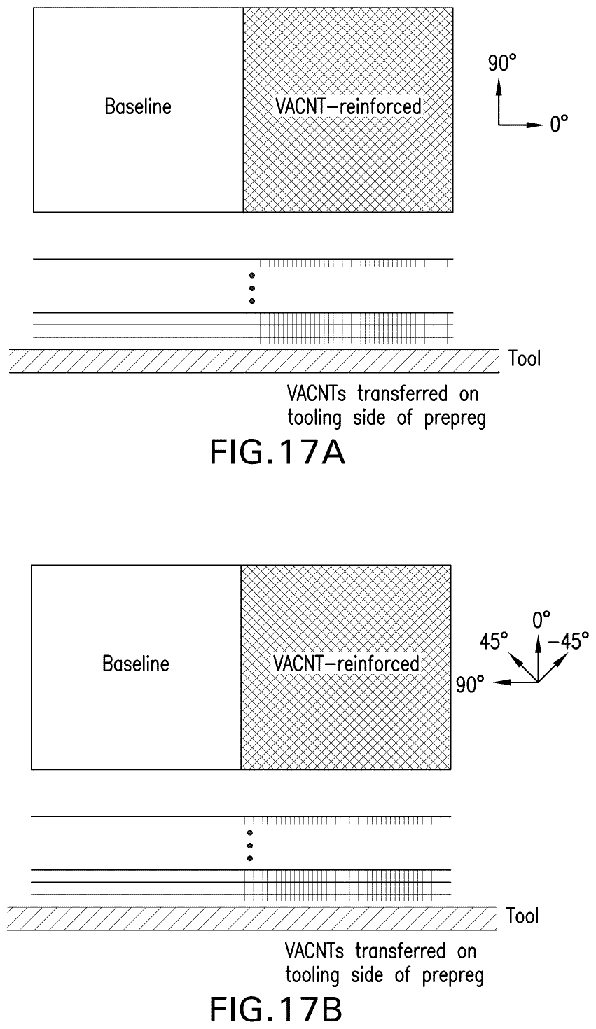

Mechanical tests were conducted on three layups: ASTM D3518 In-Plane Shear Specimens (FIG. 17A) and ASTM D5766 Open-Hole Tension Specimens (FIG. 17B), as well as an additional (i.e., a third overall) specimen as shown in FIG. 17B. For the specimen of FIG. 17A, the Panel ID is 20220111_AJMi1 (panel 1). The Material is Teijen unitape prepreg with Q183 rapid-cure resin with HTS40 fiber (250 gsm). The Panel Size is 18”×36”. The stacking sequence is 16 piles at [0, 90]_{4S}. The Expected Cured-Ply Thickness is 0.01” and the Expected Panel Thickness is 0.16”. For the specimen of FIG. 17B, the Panel ID is 20220111_AJM_2 (panel 2). The Material is Teijin unitape prepreg with Q183 rapid-cure resin with HTS40 fiber (250 gsm). The panel size is 12”×24”. The Stacking Sequence is 16 piles at [0, 90]_{4S}. The expected Cured-Ply Thickness is 0.01”. The Expected Panel Thickness is 0.16”. Another specimen, ASTM D5766 Open-Hole Tension Specimens (another), Panel ID is 20220111_AJM (panel 3), had the following layup features: The Material is Teijin unitape prepreg with Q183 rapid-cure resin with HTS40 fiber (250 gsm). The panel size is 12”×24”. The stacking sequence is 16 piles at [45, 90,−45, 0]_{2S}. The expected cured-ply thickness is 0.01”. The expected panel thickness is 0.16”.

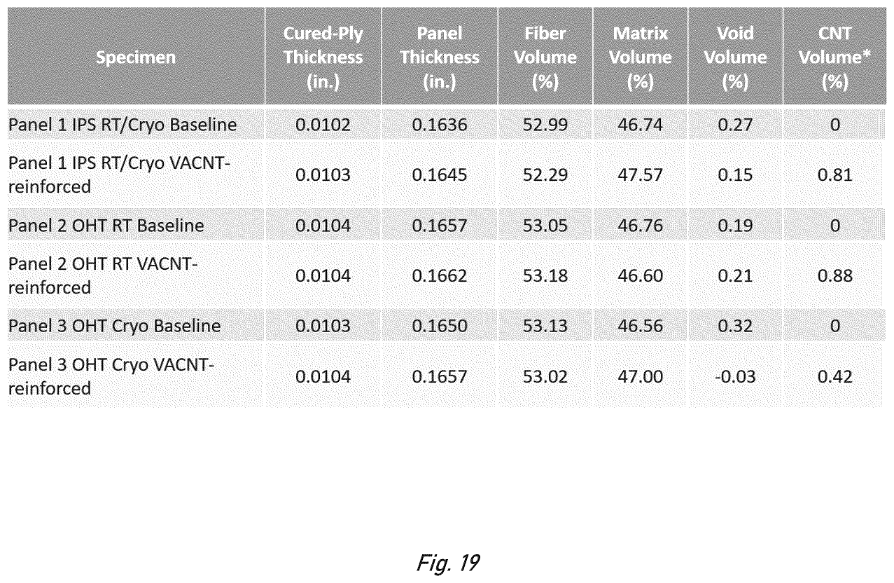

As shown in FIGS. 17A-17B, VACNTs were interdisposed between plies on one half the fabric plies, but not on the other half. Physical characteristics are shown in FIG. 19. Carbon nanotube (CNT) volume in FIG. 19 assumes a fiber density of 1.78 g/cm³, and matrix density of 1.21 g/cm³, and CNT density of 1.41 g/cm³.

### Example 1

### Cryogenic Microcracking

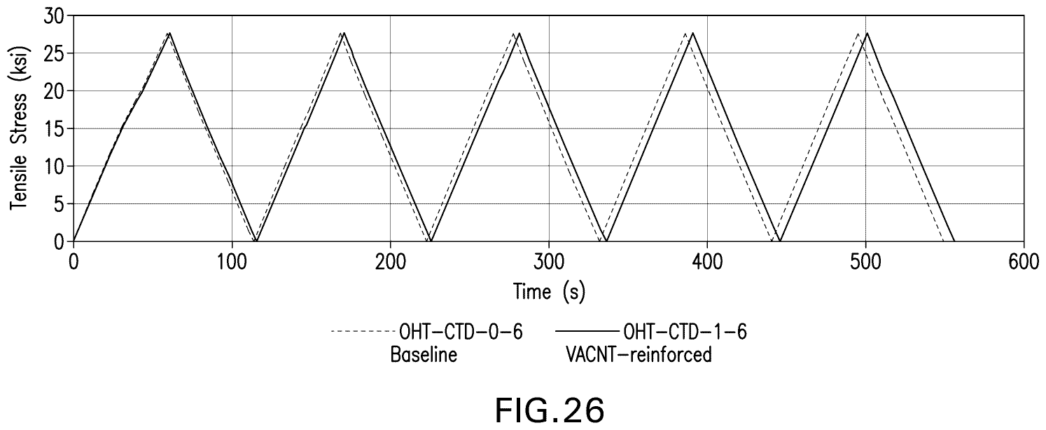

One baseline open-hole specimen and one VACNT-reinforced open-hole specimen were cycled five times from 0 to 70 percent of ultimate tensile strength (UTS) at −320° F. to induce microcracking. (FIG. 26.) Specimens had a [+45/90/−45/0]_{2S} ply layup.

Specimens' cross sections were then examined at room temperature to determine differences in cracking behavior. Distances spanning 0.5”, centered around the hole of the open-hole specimen, were examined and number of full cracks counted. Cracks penetrating multiple laminate plies were also separately counted.

Microscopy results are shown at FIGS. 4-7. Microcracking count results are shown in Table 1, below.

TABLE 1
Comparison of Microcracking

| | Number of Full Microcracks | | Microcracks per Inch | |
|---|---|---|---|---|
| | | VACNT- | | VACNT- |
| | Baseline | reinforced | Baseline | reinforced |
| 0/90° Plies | 46 | 36 | 92 | 72 |
| ±45° Plies | 10 | 5 | 20 | 10 |

The VACNT-reinforced specimen demonstrated about 20 percent lower microcracking in 90-degree oriented plies than baseline material; and about 50 percent lower microcracking 45-degree oriented plies than baseline material.

### Example 2

### Open Hole Tension Microcrack Initiation

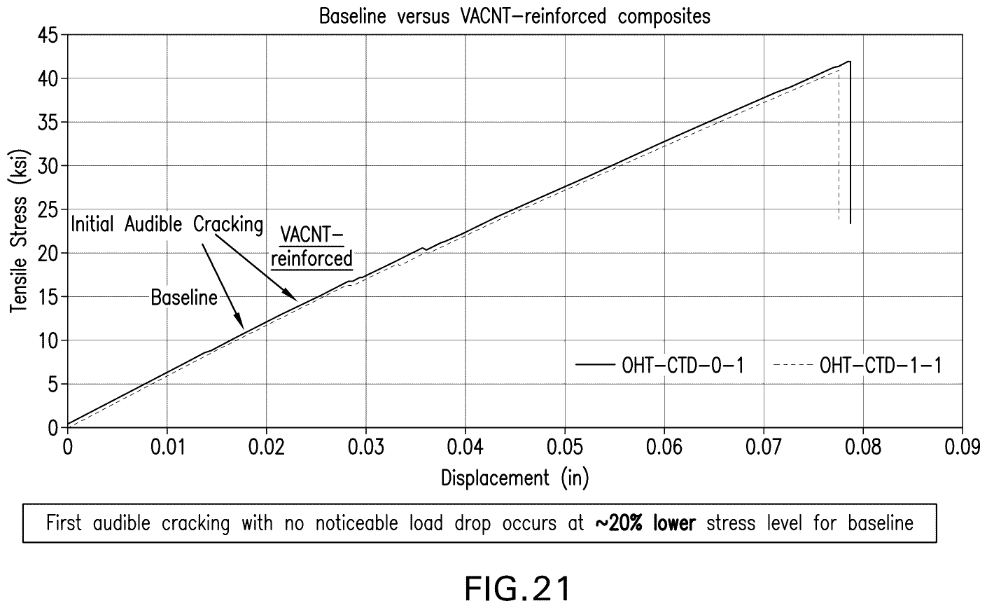

Baseline and VACNT-reinforced samples were subjected to tensile stress. First audible cracking occurred at about 20 percent lower tensile force for baseline specimen versus VACNT-reinforced specimen. Audible cracking did not correspond with measured load drop. FIG. 21.

### Example 3

### Open Hole Tension D5766 Room Temperature

Baseline and VACNT-reinforced specimens were tested according to American Society for Testing and Materials (ASTM) test D5766.

Table 2 below shows results for baseline (negative control) specimens.

TABLE 2
Baseline Room Temperature D5766 Test

| | | | Extension | | | |
|---|---|---|---|---|---|---|
| Specimen | Hole Dimeter | Area | at Max | Max Load | Ultimate | Failure |
| Label | (in) | (in²) | Load (in) | (kip) | Strength | Mode |
| OHT-RTD-0-1 | 0.251 | 0.2537 | 0.0854 | 12.44 | 49.04 | (angular, in |
| | | | | | | gage area |
| | | | | | | and middle |
| | | | | | | of gage) |
| | | | | | | “AGM” |
| OHT-RTD-0-2 | 0.250 | 0.2547 | 0.0872 | 12.45 | 48.89 | AGM |
| OHT-RTD-0-3 | 0.251 | 0.2544 | 0.0900 | 13.11 | 51.51 | AGM |
| OHT-RTD-0-4 | 0.251 | 0.2542 | 0.0861 | 12.53 | 49.29 | AGM |
| OHT-RTD-0-5 | 0.251 | 0.2541 | 0.0976 | 13.88 | 54.62 | AGM |
| Average | 0.251 | 0.2542 | 0.0893 | 12.88 | 50.67 | |
| Std Dev | 0.0004 | 0.0004 | 0.0050 | 0.6233 | 2.4514 | |
| COV(%) | 0.1783 | 0.1456 | 5.5801 | 4.8383 | 4.8380 | |

Table 3 below shows results for VACNT-reinforced specimens.

TABLE 3
VACNT-reinforced at Room Temperature D5766 Test

| | | | Extension | | | |
|---|---|---|---|---|---|---|
| Specimen | Hole Dimeter | Area | at Max | Max Load | Ultimate | Failure |
| Label | (in) | (in²) | Load (in) | (kip) | Strength | Mode |
| OHT-RTD-1-1 | 0.251 | 0.2540 | 0.0975 | 13.87 | 54.61 | (angular, in |
| | | | | | | gage area |
| | | | | | | and middle |
| | | | | | | of gage) |
| | | | | | | “AGM” |
| OHT-RTD-1-2 | 0.251 | 0.2535 | 0.0891 | 12.73 | 50.21 | AGM |
| OHT-RTD-1-3 | 0.251 | 0.2543 | 0.0893 | 12.88 | 50.65 | AGM |
| OHT-RTD-1-4 | 0.250 | 0.2547 | 0.0899 | 12.79 | 50.20 | AGM |
| OHT-RTD-1-5 | 0.251 | 0.2547 | 0.0884 | 12.70 | 49.88 | AGM |
| Average | 0.251 | 0.2542 | 0.0908 | 12.99 | 51.11 | |
| Std Dev | 0.0004 | 0.0005 | 0.0038 | 0.4945 | 1.9756 | |
| COV(%) | 0.1783 | 0.1998 | 4.1407 | 3.8056 | 3.8655 | |

### Example 4

### Open Hole Tension D5766 Cryogenic Temperature

Table 4 below shows results for baseline (negative control) specimens.

TABLE 4
Baseline −320° F. D5766 Test

| | | | Extension | | | |
|---|---|---|---|---|---|---|
| Specimen | Hole Dimeter | Area | at Max | Max Load | Ultimate | Failure |
| Label | (in) | (in²) | Load (in) | (kip) | Strength | Mode |
| OHT-CTD-0-1 | 0.250 | 0.2538 | 0.0795 | 10.93 | 43.08 | AGM |
| OHT-CTD-0-2 | 0.251 | 0.2541 | 0.0745 | 10.28 | 40.45 | AGM |
| OHT-CTD-0-3 | 0.250 | 0.2541 | 0.0787 | 10.84 | 42.64 | AGM |
| OHT-CTD-0-4 | 0.251 | 0.2541 | 0.0787 | 10.67 | 41.99 | AGM |
| OHT-CTD-0-5 | 0.251 | 0.2538 | 0.0705 | 9.782 | 38.54 | AGM |
| Average | 0.251 | 0.2540 | 0.0764 | 10.68 | 41.34 | |
| Std Dev | 0.0005 | 0.0002 | 0.0038 | 0.4726 | 1.8555 | |
| COV(%) | 0.2186 | 0.0647 | 5.0115 | 4.4235 | 4.4885 | |

Table 5 below shows results for VACNT-reinforced specimens.

TABLE 5
VACNT-reinforced −320° F. D5766 Test

| | | | Extension | | | |
|---|---|---|---|---|---|---|
| Specimen | Hole Dimeter | Area | at Max | Max Load | Ultimate | Failure |
| Label | (in) | (in²) | Load (in) | (kip) | Strength | Mode |
| OHT-CTD-1-1 | 0.251 | 0.2556 | 0.0775 | 10.45 | 40.86 | AGM |
| OHT-CTD-1-2 | 0.250 | 0.2544 | 0.0842 | 11.48 | 45.11 | AGM |
| OHT-CTD-1-3 | 0.251 | 0.2541 | 0.0810 | 11.06 | 43.51 | AGM |
| OHT-CTD-1-4 | 0.250 | 0.2537 | 0.0723 | 10.02 | 39.48 | AGM |
| OHT-CTD-1-5 | 0.251 | 0.2533 | 0.0769 | 10.28 | 40.59 | AGM |
| Average | 0.251 | 0.2542 | 0.0784 | 10.66 | 41.91 | |
| Std Dev | 0.0005 | 0.0009 | 0.0045 | 0.5980 | 2.3211 | |
| COV(%) | 0.2186 | 0.3445 | 5.7295 | 5.6109 | 5.5383 | |

### Example 5

### In-Plane Shear D3518 at Room Temperature

Baseline and VACNT-reinforced specimens were tested at room temperature according to American Society for Testing and Materials (ASTM) test D3518.

Table 6 below shows results for baseline specimens.

TABLE 6
Baseline Room Temperature D3518

| | | | Max Shear | Shear | Stress @ | .2% Offset |
|---|---|---|---|---|---|---|
| Specimen | Area | Max Load | Stress | Modulus | 5% Strain | Shear Strength |
| Label | (in²) | (lbf) | (ksi) | (Msi) | (ksi) | (ksi) |
| IPS-RTD-0-1 | 0.1716 | 3055 | 8.90 | 0.4508 | 8.856 | 5.931 |
| IPS-RTD-0-2 | 0.1721 | 3052 | 8.87 | 0.4273 | 8.753 | 6.040 |
| IPS-RTD-0-3 | 0.1718 | 3063 | 8.91 | 0.4888 | 8.758 | 5.797 |
| IPS-RTD-0-4 | 0.1716 | 3056 | 8.9 | 0.4607 | 8.743 | 5.765 |
| IPS-RTD-0-5 | 0.1713 | 3052 | 8.91 | 0.4842 | 8.748 | 5.868 |
| Average | 0.1717 | 3056 | 8.90 | 0.4624 | 8.772 | 5.880 |
| Std Dev | 0.0003 | 4.5056 | 0.0164 | 0.0252 | 0.0475 | 0.1103 |
| COV (%) | 0.1718 | 0.1475 | 0.1847 | 5.4519 | 0.5416 | 1.8766 |

Table 7 below shows results for VACNT-reinforced specimens.

TABLE 7
VACNT-reinforced Room Temperature D3518

| | | | Max Shear | Shear | Stress @ | .2% Offset |
|---|---|---|---|---|---|---|
| Specimen | Area | Max Load | Stress | Modulus | 5% Strain | Shear |
| Label | (in²) | (lbf) | (ksi) | (Msi) | (ksi) | Strength (ksi) |
| IPS-RTD-1-1 | 0.1720 | 3064 | 8.91 | 0.4700 | 8.842 | 6.008 |
| IPS-RTD-1-2 | 0.1721 | 3057 | 8.88 | 0.4929 | 8.819 | 5.842 |
| IPS-RTD-1-3 | 0.1715 | 3048 | 8.89 | 0.4934 | 8.823 | 5.907 |
| IPS-RTD-1-4 | 0.1715 | 3058 | 8.91 | 0.5049 | 8.879 | 5.991 |
| IPS-RTD-1-5 | 0.1718 | 3064 | 8.92 | 0.4840 | 8.800 | 5.893 |
| Average | 0.1718 | 3058 | 8.90 | 0.4890 | 8.833 | 5.928 |
| Std Dev | 0.0003 | 6.5727 | 0.0170 | 0.0130 | 0.0299 | 0.0696 |
| COV(%) | 0.1615 | 0.2149 | 0.1915 | 2.6531 | 0.3388 | 1.1733 |

### Example 6

### In-Plane Shear D3518 at Cryogenic Temperature

Baseline and VACNT-reinforced specimens were tested at −320° F. according to American Society for Testing and Materials (ASTM) test D3518.

Table 8 below shows results for baseline specimens.

TABLE 8
Baseline −320° F. D3518

| | | | | | Strain to | | |
|---|---|---|---|---|---|---|---|
| | | | Max Shear | Shear | Failure from | | |
| Specimen | | Max Load | Stress | Modulus | Crosshead | | Failure |
| Label | Area | (lbf) | (ksi) | (Msi) | (in/in) | Toughness | location |
| IPS-CTD-0-1 | 0.1710 | 3488 | 10.20 | 0.7891 | 0.0264 | 0.2057 | Bottom of |
| | | | | | | | Chamber |
| IPS-CTD-0-2 | 0.1716 | 3631 | 10.58 | 0.7582 | 0.0224 | 0.1675 | Top of |
| | | | | | | | Chamber |
| IPS-CTD-0-3 | 0.1710 | 3612 | 10.56 | 0.7821 | 0.0224 | 0.1675 | Top of |
| | | | | | | | Chamber |
| IPS-CTD-0-4 | | | | — | | — | |
| IPS-CTD-0-5 | 0.1712 | 3481 | 10.17 | | 0.0267 | 0.2074 | Bottom of |
| | | | | | | | Chamber |
| Average | 0.1712 | 3553 | 10.38 | 0.7765 | 0.0245 | 0.1870 | |
| Std Dev | 0.0003 | 79.5278 | 0.2228 | 0.0162 | 0.0024 | 0.0226 | |
| COV (%) | 0.1652 | 2.2383 | 2.1466 | 2.0866 | 9.7123 | 12.0709 | |

Table 9 below shows results for VACNT-reinforced specimens.

TABLE 9
VACNT-reinforced −320° F. D3518

| | | | | | Strain to | | |
|---|---|---|---|---|---|---|---|
| | | | Max Shear | Shear | Failure from | | |
| Specimen | | Max Load | Stress | Modulus | Crosshead | | Failure |
| Label | Area | (lbf) | (ksi) | (Msi) | (in/in) | Toughness | location |
| IPS-CTD-1-1 | 0.1717 | 3664 | 10.67 | 0.7690 | 0.0172 | 0.1159 | Top of |
| | | | | | | | Chamber |
| IPS-CTD-1-2 | 0.1716 | 3494 | 10.18 | 0.7461 | 0.0245 | 0.1902 | Bottom of |
| | | | | | | | Chamber |
| IPS-CTD-1-3 | 0.1718 | 3530 | 10.28 | 0.7189 | 0.0227 | 0.1658 | Top of |
| | | | | | | | Chamber |
| IPS-CTD-1-4 | 0.1716 | 3491 | 10.17 | | 0.0253 | 0.1961 | Bottom of |
| | | | | | | | Chamber |
| IPS-CTD-1-5 | 0.1716 | 3508 | 10.22 | 0.7279 | 0.0210 | 0.1476 | Top of |
| | | | | | | | Chamber |
| Average | 0.1717 | 3537 | 10.30 | 0.7405 | 0.0221 | 0.1631 | |
| Std Dev | 0.0001 | 72.4167 | 0.2088 | 0.0221 | 0.0032 | 0.0328 | |
| COV (%) | 0.0521 | 2.0472 | 2.0261 | 2.9883 | 14.6068 | 20.0871 | |

The D5766 and D3518 test results at room temperature and cryogenic temperature indicate that the addition of VACNTs between plies in a polymer matrix composite in cryogenic conditions did not show any negative effect on mechanical performance parameters. The beneficial microcracking behavior of the VACNT-reinforced enhanced composites are evidence that the VACNT-reinforced composites are beneficial to composites in cryogenic environments.

It is to be appreciated that the Detailed Description section, and not the Abstract section, is intended to be used to interpret the claims. The Abstract section can set forth one or more, but not all exemplary embodiments, of the present disclosure, and thus, is not intended to limit the present disclosure and the appended claims in any way.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in art. The invention in its broader aspects is therefore not limited to the specific details, representative apparatus and method and illustrative examples shown and described. Accordingly, departures may be made from such details without departing from the scope of the general inventive concept.

1. A microcrack-resistant laminate composition comprising:
at least two plies, each ply comprising carbon-fiber fabric impregnated with resin; and
interdisposed between each pair of plies, a substantially aligned aggregate of carbon nanotubes oriented substantially orthogonally to the plies.

2. The microcrack-resistant laminate composition of claim 1, further comprising, interdisposed between at least one pair of plies or disposed on an outer surface of an outmost ply, a layer comprising an aggregate of substantially aligned carbon nanotubes oriented substantially horizontally to the plies.

3. The microcrack-resistant laminate composition of claim 1, having a ply orientation formula of [0/90]_{4S}.

4. The microcrack-resistant laminate composition of claim 1, having a ply orientation formula of [+45/90/-45/0]_{2S}.

5. The microcrack-resistant laminate composition of claim 2, wherein a layer of carbon nanotubes oriented substantially horizontally to the plies is interdisposed at a midplane of the laminate.

6. The microcrack-resistant laminate composition of claim 1, comprising at least four plies.

7. The microcrack-resistant laminate composition of claim 1, comprising 16 plies.

8. The microcrack-resistant laminate composition of claim 1, wherein the resin is a thermosetting resin that cures at about 160° C.

9. The microcrack-resistant laminate composition of claim 1, wherein the carbon-fiber fabric is unidirectional.

10. A microcrack-resistant fluid tank comprising:
a tank shell forming an internal volume configured to receive and contain cryogenic fluid,
the tank shell comprising a carbon-fiber laminate comprising at least four plies, each ply comprising a carbon-fiber fabric impregnated with resin,
between each pair of plies is a forest of carbon-nanotubes orthogonal to the plies, and
between at least one pair of plies or on an inner surface of the tank shell is a layer of carbon nanotubes oriented substantially horizontally to the plies.

11. The microcrack-resistant fluid tank of claim 10, wherein the carbon-fiber laminate comprises 16 plies.

12. The microcrack-resistant fluid tank of claim 10, wherein interdisposed in an area between the pair of plies forming a midplane is a layer of carbon nanotubes oriented substantially horizontally to the plies.

13. The microcrack-resistant fluid tank of claim 10, comprising on an inner surface of the tank shell a layer of carbon nanotubes oriented substantially horizontally to the plies.

14. The microcrack-resistant fluid tank of claim 10, wherein microcracks do not propagate between plies when the tank shell is thermocycled at least five times between room temperature and a temperature under about 20 kelvins.

15. The microcrack-resistant fluid tank of claim 10, wherein microcracks do not propagate between plies when the tank shell is thermocycled at least five times between room temperature and a temperature under about 77 kelvins.

16. The microcrack-resistant fluid tank of claim 10, wherein the tank receives and contains cryogenic fluid without microcracks propagating between plies.

17. The microcrack-resistant fluid tank of claim 16, wherein the cryogenic fluid is liquid hydrogen.

18. A method of containing cryogenic fluid without leaks, the method comprising:
filling a tank with a cryogenic fluid,
the tank comprising a tank shell forming an internal volume configured to receive and contain the cryogenic fluid,
the tank shell comprising a carbon-fiber laminate comprising at least four plies, each ply comprising a carbon-fiber fabric impregnated with resin,
wherein interdisposed between each pair of plies is a forest of carbon-nanotubes orthogonal to the plies, and
wherein interdisposed between at least one pair of plies or disposed on in inner surface of the tank shell is a layer of carbon nanotubes oriented substantially horizontally to the plies; and
retaining the cryogenic fluid inside the tank.

19. The method of claim 18, wherein the cryogenic fluid is liquid hydrogen.

20. The method of claim 18, wherein the cryogenic fluid has a permeability through the tank shell of less than 1×10⁻¹⁸ mol/s/m/Pa at a cryogenic temperature.

21. The method of claim 20, wherein the cryogenic temperature is about 77 kelvins.

22. The method of claim 20, wherein the cryogenic temperature is about 20 kelvins.
